(19) United States
(12) Patent Application Publication
(10) Pub. No.: US 2024/0180063 A1
(43) Pub. Date: Jun. 6, 2024

(54) AUTONOMOUS DRIVER SYSTEM FOR AGRICULTURAL VEHICLE ASSEMBLIES AND METHODS FOR SAME

(71) Applicant: Raven Industries, Inc., Sioux Falls, SD (US)

(72) Inventors: Jared Ernest Kocer, Sioux Falls, SD (US); John D. Preheim, Beresford, SD (US); Travis Bunde, Lyons, SD (US); Douglas L. Fick, Garretson, SD (US)

(21) Appl. No.: 18/531,559

(22) Filed: Dec. 6, 2023

Related U.S. Application Data
(60) Provisional application No. 63/386,307, filed on Dec. 6, 2022.

(51) Int. Cl. A01B 79/00; G05D 1/80

(52) U.S. Cl. CPC A01B 79/005; G05D 1/80; G05D 2105/15

(57) ABSTRACT

An autonomous driver system for an agricultural vehicle assembly includes a sensor interface configured for coupling with one or more of vehicle sensors or implement sensors and a function interface configured for coupling with one or more of vehicle actuators or implement actuators. An autonomous driving controller is in communication with the sensor and function interfaces. The autonomous driving controller is configured to autonomously implement a planned agricultural operation with the agricultural vehicle and the agricultural implement. The controller is configured to identify and remedy one or more operation disturbances outside of the planned agricultural operation including identifying the one or more operation disturbances with one or more of the vehicle or implement sensors and selecting one or more remedial actions for the one or more operation disturbances. The controller is configured to implement the one or more remedial actions with one or more of the vehicle or implement actuators.

### CLAIM OF PRIORITY

This patent application claims the benefit of priority of Kocer, et al. U.S. Provisional Patent Application Ser. No. 63/386,307, entitled “AUTONOMOUS DRIVER SYSTEM FOR AGRICULTURAL VEHICLE ASSEMBLIES AND METHODS FOR SAME,” filed on Dec. 6, 2022 (Attorney Docket No. 2754.514PRV), which is hereby incorporated by reference herein in its entirety.

### INCORPORATION BY REFERENCE

This document incorporates by reference the entirety of U.S. Provisional Application, Ser. No. 63/024,979, entitled OBSTACLE MONITORING SYSTEMS AND METHODS FOR SAME; and U.S. patent application Ser. No. 17/321,331, entitled OBSTACLE MONITORING SYSTEMS AND METHODS FOR SAME, both assigned to Raven Industries, Inc.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc. of Sioux Falls, South Dakota. All Rights Reserved.

### TECHNICAL FIELD

This document pertains generally, but not by way of limitation, to autonomous and semi-autonomous control of agricultural vehicles and agricultural implements.

### BACKGROUND

Agricultural vehicles and agricultural implements conduct a variety of agricultural operations according to their specified functions. Tilling is conducted with tilling implements, planting with planter or seeding implements, spraying with sprayers, cultivating with cultivating implements, harvesting is conducted with combines and so on. In some examples, the agricultural implements are coupled with standalone prime movers, such as tractors, to travel fields and conduct agricultural operations.

In some examples, a user couples an implement with the prime mover and one of the implement or prime mover includes autonomous or semi-autonomous driving along a planned route and (autonomous or semi-autonomous) agricultural operations with the implement along the planned route. For instance, the user or a technician inputs a field map and indexes a planned route and agricultural operation over the field map. The prime mover, such as a tractor, drives along the planned route and the implement conducts the agricultural operation (e.g., tilling, planting, spraying, cultivating, harvesting, grain cart transporting, mowing, baling or the like).

### OVERVIEW

The present inventors have recognized, among other things, that a problem to be solved includes addressing operation disturbances that arise in non-ideal environments (e.g., the real world) that autonomous systems fail to recognize or address because they are outside of base driving or agricultural operation conduct for the autonomous system. For example, autonomous agricultural vehicles and implements are able to drive along a planned route and conduct agricultural operations along that route. However, during an actual agricultural operation a human operator (e.g., driver, user or the like) drives the route while conducting the agricultural operation and, at the same time, addresses a multitude of unique operation disturbances and situations that are related and unrelated to driving and conducting the operation.

For instance, maintenance issues such as flat tires, engine issues or the like are in various examples addressed by the operator through recognition of the issues (e.g., with sight, feedback felt from the vehicle or implement, hearing, displays or the like) and each issue is addressed with non-autonomous interventions, alternative operations or the like based on the experience and knowhow of the operator. In some examples, the operator recognizes the issue is of a secondary nature and the agricultural operation may continue with an alternative or workaround instituted by the operator, for example with a full suite of controls that permit multiple (operator determined) combinations of prime mover or implement operations known to the operator based on skill and experience. In other examples, the operator recognizes the issue is more serious and arrests the operation of the prime mover to avoid damage to the vehicle, livestock, crops or the field.

In still other examples, performance issues are addressed by the operator through recognition of those issues (e.g., with sight, sound, displays, feel or the like) and instituting non-autonomous interventions, alternatives or the like based on the experience and knowhow of the operator. For instance, the operator recognizes fouling of implements, blocking of ground engagement elements, incorrect surface finish (e.g., soil clods having too large a profile), inaccurate implement depth, loss of traction (slippage), rise in power draw, operation of implements outside of acceptable parameters or the like. The operator has access to the full suite of controls for the prime mover (such as a tractor) and the implement and intervenes using the controls with combinations of actions to address the issues as they are recognized. For instance, intervention includes, but is not limited to, application of additional engine power, operating the transmission (e.g., to a lower gear), reversing a vehicle and implement, raising an implement to unblock the fouled implement or to provide a specified surface finish (e.g., clods having a profile/width of one inch or less while tilling, to minimize tilling of the underlying saturated soil or the like), adjusting implement angles (such as gang angles), conducting one or more maintenance procedures such as flushing sprayer nozzles, combinations of the same, or the like. The operator conducts the interventions in a manner consistent with the skill of the operator, experience, understanding of the capabilities of the prime mover and implement or the like.

Additionally, other issues arise while conducting agricultural operations that may extend beyond autonomous driving and autonomous conduct of agricultural operations. For instance, obstacles including livestock, fences, rocks, brush, washouts, standing water, other vehicles or implements, humans or the like interfere with autonomous driving and autonomous agricultural operations. In some example systems, human operators are alerted to these obstacles, and then intervene to divert the prime mover, adjust operations, call for assistance or the like. As with other issues noted herein, the skill and experience of the operator and the operator understanding of the capabilities of the prime mover and implement permit the conduct of various combinations of the actions to address and overcome the obstacles.

The issues noted herein, and other similar issues (collectively referred to as operation disturbances, issues or the like), in many examples fall outside of the capabilities of autonomous prime movers and autonomous agricultural implements. Instead, the autonomous prime movers and autonomous agricultural implements provide automated driving and agricultural implement operations for ideal circumstances with limited or no ability to address issues that are related or tangential to driving or agricultural operations. Instead, the autonomous systems provide notifications to an operator to precipitate human interaction to address the issues.

The present subject matter can help provide a solution to this problem, with an autonomous driver system that conducts autonomous driving and agricultural operations, and at the same time addresses issues related to driving and agricultural operation as well as tangential issues (e.g., collectively operation disturbances) in an automated manner that replicates the skill and experience of a human operator and also leverages the understanding of the capabilities of the prime mover and agricultural implement. Further, the autonomous driver system in some examples improves upon responses provided by human operators by identifying operation disturbances and implementing associated remedies in an automated fashion and in an ongoing state of observation. The ongoing observation and implementation of remedies improves upon drivers that may require more time to identify an operation disturbance or distracted drivers that are delayed in identifying the operation disturbance.

The autonomous driver system provides an interface with the user to select various inputs to generate a composite autonomous configuration file. Delivery of the composite autonomous configuration file to one or both of the agricultural vehicle, implement or the like (referred to collectively as an agricultural assembly) permits the autonomous operation of the agricultural assembly. In one example, the inputs include a field selection, implement selection (e.g., for the desired operation), and a prime mover selection to drive the selected implement. For instance, the user is provided with a virtual catalog or garage including available fields, implements and prime movers. Each of these selectable inputs corresponds to respective real counterparts. Additionally, each of the selectable inputs includes associated characteristic bundles. For instance, a field selection includes a field characteristic bundle of one or more of a field map, crop planted or that will be planted, row spacing, indexed obstacles, weather conditions or the like.

An implement selection includes an implement characteristic bundle having one or more of dimensions of the implement, turning radius, weight, hitch type, characteristics of implement tools (e.g., number of row units, spacing, disk size, knife dimensions, tool actuator characteristics, nozzle type, product injection capability, boom dimensions, reservoir size, reservoir contents, seed hopper contents or the like). Additionally, the characteristic bundle includes information on sensors included with the implement, such as, but not limited to, vision sensors, radar, LiDAR, ultrasound, implement tool sensors (e.g., hydraulic pressure, depth, position, torque, force or the like).

A prime mover selection includes a prime mover characteristic bundle having one or more of dimensions of the vehicle, turning radius, weight, power, transmission, wheel or tire arrangement, hitch type or the like. Additionally, the characteristic bundle includes information on sensors included with the agricultural vehicle (e.g., prime mover), such as, but not limited to, vision sensors, radar, LiDAR, ultrasound, engine, transmission, suspension, tire pressure, slippage, power take off sensors (e.g., hydraulic pressure, torque, force or the like) or the like.

The autonomous driver system collects the selected characteristic bundles including the various characteristics of each of the selected field, implement and prime mover and generates or accesses a library or catalog of potential operation disturbances that may arise during operation. This library or catalog is referred to herein as an autonomous agronomic tree (or an agronomic tree). In one example, the agronomic tree includes various branches of operation disturbances and corresponding interventions (remedial actions) that are included with the characteristic bundles, generated from queries of the operator or provided from an existing storage site (e.g., a local memory associated with the prime mover or implement, cloud based source or the like sometimes referred to as an operation disturbance and remedy log). These branches include known or previously encountered operation disturbances that have occurred and specifies how those operation disturbances were detected, identified and remedied.

One example branch of the agronomic tree includes tire slippage of the prime mover that was previously detected and identified with a combination of sensed characteristics from prime mover power and tire sensors, visual sensors (e.g., directed at the tires), speed sensors, transmission (speed) sensors or the like. In the tire slippage branch with sensed slippage exceeding a slippage threshold, slippage is first addressed with remedial actions, such as, an adjustment to gang angle of a tillage implement coupled with the vehicle, then adjustment of the height of the back gang if the implement has that capability, followed by adjustment of the implement height (e.g., retracting the tillage implement) driving out of the zone of slippage and then attempting redeployment of the tillage knives, disks or the like. Optionally, the operation disturbance is monitored throughout implementation of the remedial operations, and in this example if slippage falls beneath a slippage threshold the remedial actions are arrested (including gradually tapered) and the agricultural operation continues as provided by an agricultural operation controller. If the slippage operation disturbance continues after these remedial actions or slippage increases further (e.g., to an arresting slippage threshold) remedial action includes arresting the operation of the vehicle, alerting a remote operator and requesting assistance (e.g., towing).

In another example, with a vehicle system including the agricultural vehicle (optionally with an onboard implement, like a sprayer boom, harvester head or the like) with the slippage operation disturbance exceeding a slippage threshold the branch of the agronomic tree includes shifting to a higher gear or increasing hydraulic flow to rotate the ground engaging elements at an elevated speed to drive out of the slippery zone. Optionally, the operation disturbance is monitored and one or more additional remedial actions are implemented if slippage does not fall beneath the slippage threshold. In one example, the vehicle stops, is reversed, stopped and then redirected forward to drive out of the slipper zone. If slippage continues (e.g., does not fall below the remedial threshold or increases above an arresting slippage threshold) the vehicle operation is arrested, a remote operator is alerted and optionally assistance is requested (e.g., towing).

In yet another example, the autonomous driving system includes variations on operation disturbances in other branches of the agronomic tree. For instance, slippage (greater than a slippage threshold) on a detectable grade (greater than a grade threshold) is observed with one or more of an accelerometer, topographical analysis of a field map, vertical reference unit (VRU), decrease or draw on engine power or the like in combination with slippage recognition as provided herein. With this variation of the operation disturbance having slippage above a slippage threshold and grade above a grade threshold remedial actions include one or more of engine power increase (e.g., increase in rpms), increase of power through delivery hydraulic flow to a differently geared hydraulic motor or the like. As with previous disturbances the operation disturbance is optionally monitored and the remedial actions are applied in sequence (or parallel if prescribed in that manner) while the disturbance remains above the threshold(s). In another example, the operation disturbance may change during implementation of the remedial action, for instance if the detected grade falls below the grade threshold. In this circumstance the autonomous driving system changes the operation disturbance to a slippage branch in contrast to the slippage with grade branch.

In another example, additional queried branches are generated for the composite autonomous configuration file based on the characteristic bundles selected by the user. As discussed herein, the characteristic bundles for each of the field, implement and prime mover includes various characteristics including dimensions (e.g., of the field, implement, prime mover), sensors, capabilities of the prime mover or implement or the like. As previously discussed, an operator is able to detect and identify various issues in the vehicle system (implement and prime mover) through sight, feel, hearing and use of displays or other output devices of the system. The autonomous driver system with the selected characteristic bundles includes one or more of pre-generated or selectable operation disturbance and remediation branches or assembles queries for the user to permit detection and identification of operation disturbances and remediation of the operation disturbances. For example, the sensors provided with each of the implement and the prime mover are provided to the automated driver system based on the submission of the respective characteristic bundles. The automated driver system includes an operation disturbance query generator that generates queries for the user based on predicted sensor inputs representative of operation disturbances.

In one example, a tillage implement such as a knife, disk or the like is blocked with debris. With an operator in a vehicle system the operator identifies the blockage through one or more of an observation of a decrease in prime mover speed, an audible change in engine noise, inertia felt as the implement intercepts the blockage and slows the vehicle system, or seeing blockage upon viewing the implement. With the autonomous driver system the operator is not onboard or is engaged in other activities (e.g., coordinating other vehicles, remote or the like). Instead, the sensors on one or both of the implement or the prime mover detect characteristics associated with blockage. For instance, a torque sensor associated with the engine notes a rise in torque, or a decrease in engine rotations per minute (rpm) are detected. With the implement, the impact or ongoing drag on the blocked implement is detected with hydraulic pressure sensors, visual sensors (e.g., cameras) directed at the tillage knives or disks or the like. The autonomous driver system consolidates these potential sensor options and queries the user to assess inputs that are indicative of blockage. The system queries the user to provide one or more remedial actions for execution upon detection and identification of the queried operation disturbance. By consolidating sensors the system determines resources available for detection and identification of operation disturbances and queries the user to provide future autonomous detection and identification. The system then conducts additional queries or suggestions to determined specified actions to address the operation disturbance. For instance, with blockage, the user specifies the prime mover to increase power to initially overrun or clear the blockage. If the blockage remains (determined with continued monitoring with the selected sensors) additional remedial actions are implemented including reversal of the prime mover to back away from the blockage, lifting of the implement to loosen engagement with the blockage, forward travel of the implement to pass the observed blockage, and re-engagement of the implement with the soil.

In another example, the tire slippage of the prime mover that was previously detected and identified with a combination of sensed characteristics from prime the mover power, tire sensors, visual sensors (e.g., directed at the tires), speed sensors, transmission (speed) sensors or the like is further refined to include sensing by the implement. For example, the sensors of prime mover as well as the implement are available to further detect and identify the cause of the slippage (snagging or blocking of the implement) and thereby provide enhanced autonomous remedies. By way of user queries the autonomous driver system assembles a combination of sensor inputs indicative of tire slippage caused by blocking of the implement. For instance, the torque sensor associated with the engine indicates a decrease in torque, and an increase in engine rotations per minute (rpm) is detected. Tire slippage is detected with visual sensors directed at the prime mover tires, through rotational sensors coupled with the prime mover or a combination of a transmission sensor and a ground speed sensor (with their measurements compared and a magnitude of the differential indicating slippage percent). With the implement, the impact or ongoing drag on the blocked implement is detected with hydraulic pressure sensors, visual sensors (e.g., cameras) directed at the tillage knives or disks or the like. The autonomous driver system consolidates these potential sensor options and queries the user to assess inputs that are indicative of tire slippage caused by blockage. The system then queries the user with suggestions (including additional queries) to address the operation disturbance. For instance, with slippage caused by blockage, the user specifies the implement to change the gang angle of the tillage disk by a specified angle, adjust the height a specified amount of the implement back gang, raise the implement a specified amount or the like, potentially in that order with continued monitoring of slippage until slippage falls below a threshold (and then remediation is ended).

In addition, queries from the autonomous driver system generate additional optional remedial actions for the operation disturbance or remedial actions for a related operation disturbance, such as power draw (decrease in power caused in part by the blockage or slippage caused by blockage). The remedial actions for power draw are optionally conducted in parallel with those for slippage or blockage including increasing of engine RPMs, shifting down in gear or the like potentially in that order until the power draw threshold is achieved (e.g., rpms remain above a power threshold). Optionally, the user queries (including system suggestions or the like) determine the priorities of the various remedial actions with the implement and prime mover or conduct the actions in parallel until slippage falls below the threshold, the power draw abates (rpms remain above a power threshold) or the like.

In still another example, a tillage implement is navigated along a swath that includes a rock or other obstacle that may interfere with one or more of the tillage knives, disks or the like. With an operator in a vehicle system the operator identifies the potential obstacle through visual identification or, in the case of collision between the obstacle and a knife or disk, the haptic feedback of the impact or the sensation of a decrease in speed, audible decrease in power or the like. With the autonomous driver system sensors on one or both of the implement (e.g., the tillage implement) or the prime mover detect characteristics associated with the obstacle. For instance, a torque sensor associated with the engine notes a rise in torque, or a decrease in engine rotations per minute (rpm), accelerations (including decelerations) are detected with accelerometers, inertial measurement units (IMU) or the like, thereby indicating collision with the obstacle. With the implement, the impact or ongoing drag on the blocked implement is detected with hydraulic pressure sensors, visual sensors (e.g., cameras) directed at the tillage knives or disks, accelerometer, inertial measurement unit or the like. In another example, visual sensors directed in front of the implement, prime mover or both, sense the obstacle prior to collision. The autonomous driver system identifies the observed obstacle, such as a rock, tree limb or the like, based on comparison with logged images or other characteristics regarding the obstacles. The autonomous driver system consolidates these potential sensor options and queries the user to assess inputs that are indicative of an obstacle including a potential collision with the obstacle. The system queries the user to provide one or more remedial actions for execution (including selection of suggested remedial actions) upon detection and identification of the queried operation disturbance. By consolidating sensors the system determines resources available for detection and identification of operation disturbances and queries the user to select from those resources (sensors) for future autonomous detection and identification. The system then conducts additional queries or suggestions to determined specified actions to address the operation disturbance.

For instance, with an obstacle, the user specifies the prime mover and tillage implement to act in a manner appropriate to a characteristic of the obstacle (e.g., mass, profile, structural integrity or the like) relative to one or more thresholds. In one example, with an obstacle having one or more characteristics (mass, structural integrity or the like, corresponding sensed deceleration or similar) that fall beneath a normal operation threshold the autonomous driver system continues with normal operation including driving and tillage operations along the planned path as the knives, disks or the like will readily overrun or have minimal difficulty overcoming the obstacle. In another example, with an obstacle having one or more characteristics (e.g., mass, structural integrity, detected acceleration/deceleration) above a normal operation threshold (including within a modified operation threshold range) the autonomous driver system raises one or more row sections, knives, disks or the like of the tillage implement that are presently aligned with the obstacle to minimize (including avoid) damage to the associated portions of the tillage implement. In still another example, with an obstacle having one or more characteristics (including detected acceleration/deceleration) above an obstacle avoidance threshold the autonomous driver system raises all row sections, knives, disks or the like of the tillage implement to avoid a collision with the obstacle that otherwise presents a risk of damage to the implement. Optionally, the autonomous driver system interrupts the driving along the planned path and plans an obstacle avoidance route around the obstacle that permits continued tillage (or another agricultural operation) while avoiding the obstacle.

This process of conducting operation disturbance and remedy queries with the user is repeated for various operation disturbances to ensure their detection and identification and remedial action when identified. In some examples, the operation disturbance and remedy queries are conducted remotely and prior to operation (e.g., on a tablet computer). In another example, the operation disturbance and remedy queries are conducted by the user with onboard displays, such as touchscreens associated with the prime mover before or during an agricultural operation. In still other examples operation disturbances and remedial actions provided with characteristic bundles, pulled from databases or online catalogs, or the like.

The autonomous agronomic tree is filled with various operation disturbance branches (e.g., detection, identification, remediation) determined from the operation disturbance and remedy log, the operation disturbance and remedy queries or the like. The autonomous driver system optionally generates a path plan for the vehicle system and prescriptions for implementing the agricultural operation. The path plan, prescriptions for the agricultural operation and the autonomous agronomic tree are provided as components of the composite autonomous configuration file to the one or more controllers of the vehicle system (optionally components of the autonomous driver system). The controllers and composite autonomous configuration file conduct autonomous path planned driving, agricultural operations, and identify and address operation disturbances in the manner of an autonomous driver that replicates the skill and experience of a human operator by way of leveraging the capabilities of the prime mover and the agricultural implement. Further, the autonomous driver system identifies operation disturbances and implements the associated remedies in an automated fashion in an ongoing state of observation that improves upon drivers that may require more time to identify an operation disturbance or distracted drivers that are delayed in identifying the operation disturbance.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example a prime mover and a tillage implement.

FIG. 2 is a perspective of an agricultural sprayer.

FIG. 3 is a perspective view of a combine.

FIG. 4 is a schematic diagram of one example of an agricultural vehicle architecture.

FIG. 5 is a schematic diagram of one example of an agricultural implement architecture.

FIG. 6 is a schematic diagram of one example an autonomous driver system including and agricultural operation module and an interventional control module.

FIG. 7 is a schematic diagram of one example of an agronomy tree, the agronomy tree having a plurality of branches for each operation disturbance and associated remedies.

FIG. 8 is a schematic diagram of an example configurator configured to assemble autonomous configuration profiles and agronomy trees.

FIG. 9 is a schematic diagram showing one example of queries for generation of an agronomy tree.

### DETAILED DESCRIPTION

Examples of autonomous driver systems for agricultural vehicle assemblies (herein agricultural assemblies) are described herein. The example autonomous driver systems are provided in one or more processor systems. The example autonomous driver systems implement and control autonomous operation of agricultural assemblies including the semi-autonomous and fully autonomous driving of the assemblies along a planned paths in fields and conduct of agricultural operations including, but not limited to, tilling, planting, seeding, spraying, cultivating, harvesting, bailing, crop offloading and loading (e.g., grain cart operation) or the like.

The autonomous driver systems described herein are further configured to detect and identify operation disturbances in the manner of a human operator. For instance, problems that arise as part of an agricultural operation or that are distinct to the present agricultural operation and relate to the function (operation) of the agricultural assembly. As described herein and in equivalents, the operation disturbances include, but are not limited to, blocking of implement tools, fouling of sprayer nozzles, slippage of ground engaging elements, collisions or predicted collisions with obstacles, seizing or dragging of obstacles, tire deflation, hydraulic oil loss of pressure or the like. The autonomous driver systems are interfaced with one or more of vehicle or implement sensors to detect the operation disturbances. The output of the sensors is compared with one or more of thresholds included with operation disturbances as branches of an agronomic tree of the autonomous driver systems to identify (e.g., recognize) the operation disturbance or disturbances. In other examples, the autonomous driver system interfaces with an autonomous perception controller including a machine learning algorithm or artificial intelligence module that receives the output of the sensor (or sensors), assesses the output, and thereby identifies operation disturbances.

The autonomous driver systems include, for instance in the agronomic tree, remedial actions associated with each of the operation disturbances. The remedial actions are, in one example components of the branches along with the associated operation disturbances. The remedial actions are specified actions conducted with one or more of the vehicle or implement actuators that attempt to overcome or address the identified operation disturbances. A branch of the agronomic tree for an operation disturbance, such as a blocked tilling knife or disk, includes one or more associated remedial actions that are conducted by the vehicle assembly to address that operation disturbance. For instance, raising of the implement knife or disk and continued forward movement to bypass a rock operation disturbance that is causing blocking. In another example, the remedial actions include, increasing the tractor engine power to drive through the rock. In still another example, the remedial actions include reversing the agricultural assembly, navigating around the rock, and reinitiating the autonomous operation. Optionally, a plurality of remedial actions are provided in the agronomic tree branch including priorities for the same, thresholds that trigger one or more of the remedial actions or the like.

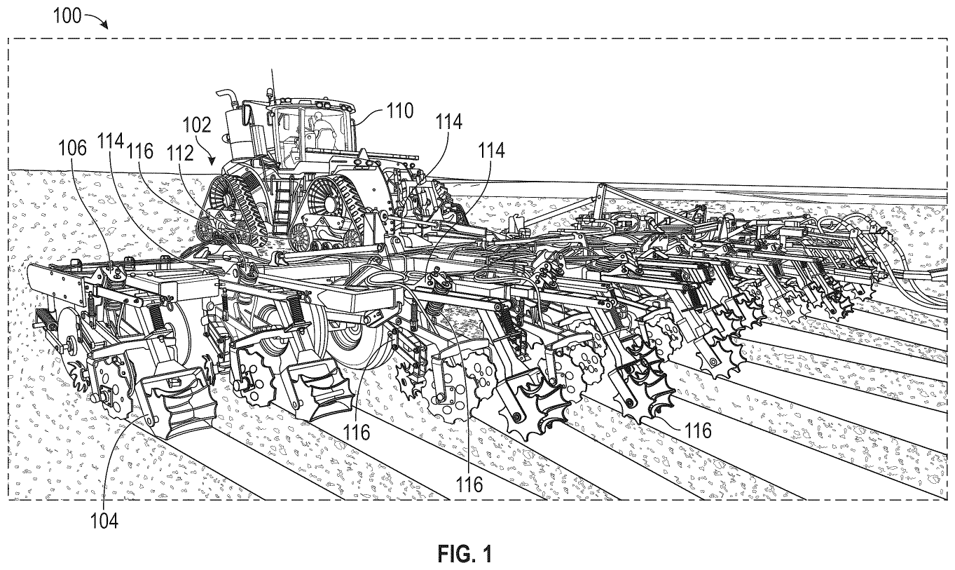

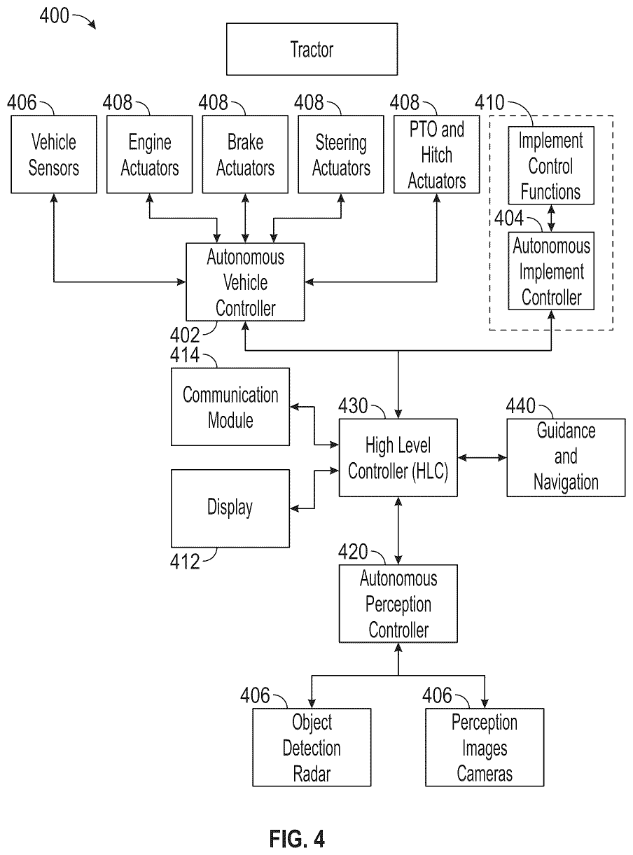

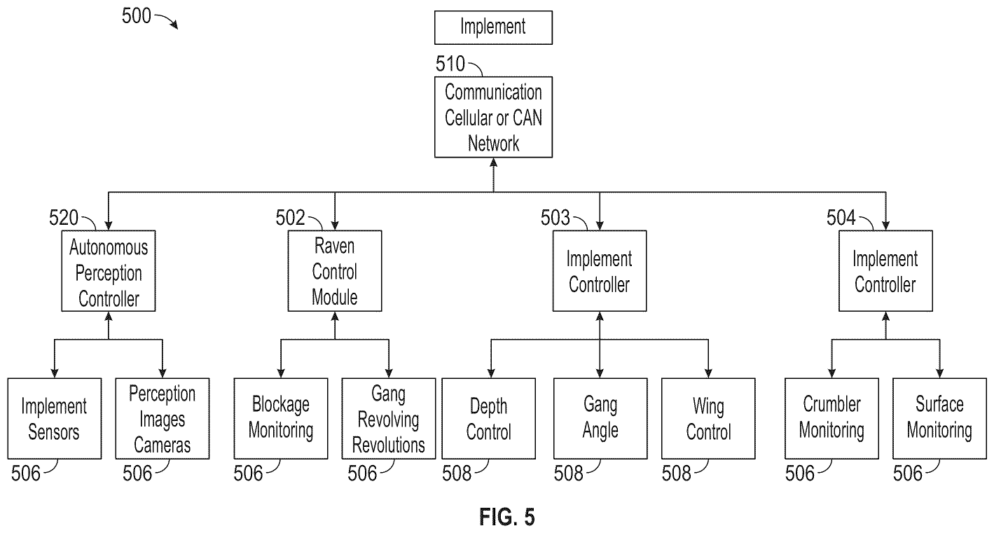

FIGS. 1-3 herein provide various examples of agricultural vehicles and implements including their associated sensors and actuators (e.g., vehicle and implement sensors and actuators). FIGS. 4 and 5 provide example architectures of an agricultural vehicle and agricultural implement, respectively. These examples are illustrative of the varied sensors, actuators, vehicles, and implements the autonomous driver systems described herein interface with to conduct autonomous conduct of an agricultural operation and the sensing, identification and remediation of operation disturbances. The autonomous driver systems described herein permit the conduct of autonomous agricultural operations and approximate the adaptability of a human operator to conduct those operations and address disturbances with various remedial actions.

FIG. 1 is a perspective view of one example of an agricultural assembly 100 including a tractor as the agricultural vehicle 102 and a tillage implement 104 such as a plow, disks, rippers or the like coupled with the agricultural vehicle 102. The agricultural implement includes, in this example, a plurality of row sections 106. Each of the row sections includes one or more implement tools including disks, rippers, knives, chisels, rolling baskets or the like.

The agricultural vehicle 102 in this example is a tracked tractor having tracks as ground engaging elements. In other examples, the ground engaging elements include tires, tracks, runners, combinations of the same or the like. The agricultural vehicle 102 includes vehicle sensors 110 and vehicle actuators 112. The vehicle sensors 110 include one or more sensors that permit autonomous agricultural operations, driver assisted operation, or human driver operation. Example vehicle sensors 110 include, but are not limited to, one or more of visual, video, laser, radar, LiDAR, ultrasound, sensors or the like to permit observations proximate to or directed away from the agricultural vehicle 102. For instance, the vehicle sensors 110 in this example facilitate observation based steering, obstacle detection or the like. In other examples, these vehicle sensors 110 are directed toward the agricultural vehicle 102, the agricultural implement 104, or both to permit the observation of the vehicle or implement and the associated performance of an agricultural operation. The autonomous driver systems described herein, in various examples, interface with the vehicle sensors 110 to permit the sensing and identification of operation disturbances. In other examples, the vehicle sensors 110 permit observation of remedial actions controlled by the autonomous driver systems to address and assess those remedial actions relative to operation disturbances (e.g., to assess successful or unsuccessful remediation).

Other example vehicle sensors 110 include, but not are not limited to, torque, speed, acceleration, inertial measurement unit (IMU), tachometer, dynamometer sensors or the like to monitor performance of the vehicle. In other examples, the agricultural vehicle 102 includes vehicle sensors 110, such as position sensors, including one or more of a global positioning system (GPS) or real-time kinematic (RTK) sensors to monitor the position of the agricultural vehicle 102 (and implement 104). Additional vehicle sensors optionally include load cells, radiofrequency identification (RFID), short range radio frequency, infrared, temperature, encoders (e.g., hitch position), or the like.

As previously discussed, the agricultural vehicle 102 includes various actuators 112 to permit movement, towing of implements, powering and control of implements or the like. The vehicle actuators 112 include motor or engine associated actuators, such as throttle, brake, transmission, clutches, centrifugal clutches, variable speed pulley actuators or steering actuators. In other examples, the vehicle actuators 112 include hydraulic pumps, motors or the like and actuators for controlling hydraulic pressure and hydraulic flow rate. Example actuators includes hydraulic valves, hydraulic cylinders or control valves.

As provided herein, the autonomous driver system includes sensor and function interfaces to provide communication of sensor measurements, observations or signals to the autonomous driving controller having the agricultural operation module and the interventional control module discussed herein. For example, the autonomous driver system cooperates with existing sensors 110 of the vehicle (and implement sensors 114) to recognize operation disturbances (with the sensors), select remedial actions, and implement the remedial actions with actuators 112, 116 as described herein autonomously, and then return to conducting the agricultural operation (including conduct of the agricultural and conduct of the remedial action concurrently). The interventional control module implements the remedial actions, for instance with one or more of the vehicle or implement actuators 112, 116, to address identified operation disturbances.

The agricultural implement 104 in this example is a tillage implement and includes its own implement sensors 114 and implement actuators 116. The implement sensors 114 include one or more sensors that permit autonomous agricultural operation, driver assisted operation (e.g., semi-autonomous), or driver operation. The implement sensors 114 are, in some examples, similar to sensors 110 provided with the agricultural vehicle 102. Optionally, the implement sensors 114 are oriented in different directions, for instance to observe different zones, targets or the like (e.g., obstacles fouling the implement 104 in contrast to obstacles ahead of the vehicle 102). The implement sensors 114 include one or more of visual, video, laser, radar, LiDAR, ultrasound sensors, for instance to monitor the implement, performance of the implement, conditions around the implement (including to the sides, in front, behind or beneath the implement). In other examples, the implement sensors 114 include pressure sensors, flow meters, cameras or video cameras to monitor soil, operation of the knives, disks, rippers, rolling baskets, flow of agricultural product (e.g., ammonia, fertilizer) or the like. Optionally, implement sensors 114 include load cells, sensors associated with actuators to monitor actuator characteristics or the like, for instance the deployment or retraction of tillage implement wings, depth of knives, disks or the like.

In still other examples, the implement sensors 114 include radio-frequency identification (RFID), short range radio frequency, infrared, temperature, encoder (position of wings, implement tools or the like), moisture, hyperspectral (NDVI) sensors or the like. Optionally, the implement 104 includes one or more positions sensors including, but not limited to, GPS, RTK sensors or the like.

The tillage implement 104 further includes implement actuators 116 to control the operation of the implement 104 while conducting an autonomous operation. The implement actuators 116 include actuators that control one or more of gang angle, gang height, implement height, disk depth, knife depth, rolling baskets. In some examples, hydraulic, pneumatic or electromechanical systems control the various features of the implement 104. Accordingly, the implement actuators 116 include one or more of hydraulic pumps, motors, control valves or similar that control one or more of hydraulic oil pressure or hydraulic oil flow rate. Optionally, with pneumatic or electromechanical systems pneumatic pumps, control valves, stepper motors, or servo motors are provided as actuators 116. In other examples, the implement 104 includes actuators 116 such as an agricultural product pump, control valves, modulating nozzles or the like to permit the application of agricultural products like ammonia, fertilizers or the like.

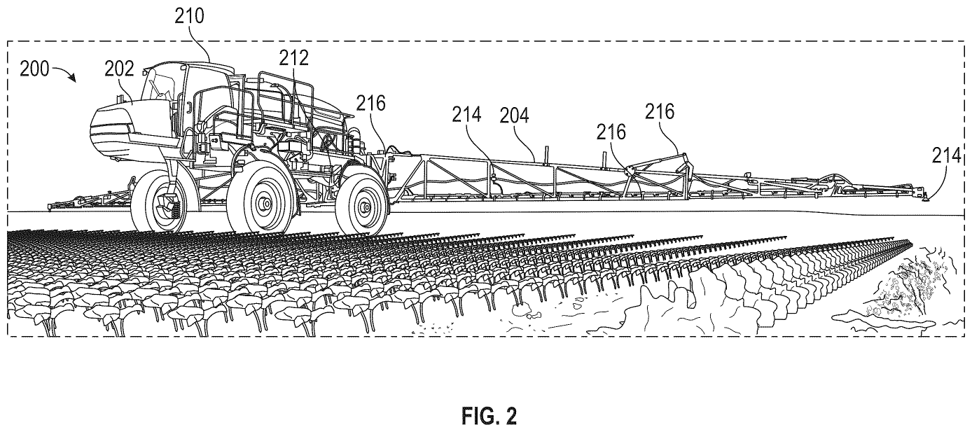

FIG. 2 is a perspective view of one example of an agricultural assembly 200 including a sprayer truck as the agricultural vehicle 202 and a one or more sprayer booms as the implement 204. The agricultural implement 204 includes, in this example, a plurality spray nozzles including static nozzles, adjustable nozzles, remotely modulating nozzles (e.g., with a modulating nozzle profile, variable duty cycle, frequency or combinations of the same).

The vehicle sensors 210 and vehicle actuators 212 of the agricultural vehicle 202 are similar in some regards to sensors and actuators provided with other vehicles, such as the agricultural vehicle 102. In other regards the vehicle sensors 210 and vehicle actuators 212 are varied based on the type of agricultural vehicle, manufacturer, model, model year or the like. The vehicle sensors 210 include one or more sensors that permit autonomous agricultural operation, driver assisted operation (e.g., semi-autonomous), or human driver operation. Example vehicle sensors 210 include, but are not limited to, one or more of visual, video, laser, radar, LiDAR, ultrasound, sensors or the like to permit observations proximate to or directed away from the agricultural vehicle 202. For instance, the vehicle sensors 210 in this example facilitate observation based steering, obstacle detection or the like. In other examples, the vehicle sensors 210 permit observation of crops, such as forthcoming crops, crops proximate to sprayer nozzles or the like, to facilitate precision husbandry including, but not limited to, varied flow rates, droplet sizes, concentrations and constituencies of the agricultural product. With regard to an agricultural sprayer vehicle 202 in some examples sensors (e.g., radar, ultrasound or LiDAR) are directed between the ground engaging elements to permit the detection of crop rows to decrease overrunning through guidance between the crop rows.

The autonomous driver systems described herein, in an example, interface with the vehicle sensors 210 to permit the sensing and identification of operation disturbances. In other examples, the vehicle sensors 210 permit observation of remedial actions controlled by the autonomous driver systems to address and assess those remedial actions relative to operation disturbances (e.g., to assess successful or unsuccessful remediation).

Other example vehicle sensors 210 include, but not are not limited to, torque, speed, acceleration, inertial measurement unit (IMU), tachometer, dynamometer sensors or the like to monitor performance of the vehicle. The agricultural vehicle 202 includes vehicle sensors 210, such as position sensors, including one or more of a global positioning system (GPS) or real-time kinematic (RTK) sensors to monitor the position of the agricultural vehicle 202 (and implement 204). Additional vehicle sensors optionally include load cells, radiofrequency identification (RFID), short range radio frequency, infrared, temperature, encoders (e.g., hitch position), or the like.

The agricultural vehicle 202 includes various actuators 212 to permit movement, including navigation between crop rows, towing of implements, powering and control of implements including sprayer pumps, control valves, modulation nozzles or the like. The vehicle actuators 212 include motor or engine associated actuators, such as throttle, brake, transmission, clutches, centrifugal clutches, variable speed pulley actuators or steering actuators. In other examples, the vehicle actuators 212 include hydraulic pumps, motors or the like and actuators for controlling hydraulic pressure and hydraulic flow rate. Example actuators includes hydraulic valves, hydraulic cylinders or control valves.

As provided herein, the autonomous driver system includes sensor and function interfaces to provide communication of sensor measurements, observations or signals to the autonomous driving controller having the agricultural operation module and the interventional control module discussed herein. For example, the autonomous driver system cooperates with existing sensors 210 of the vehicle (and implement sensors 214) to recognize operation disturbances (with the sensors), select remedial actions, and implement the remedial actions with actuators 212, 216 as described herein autonomously, and then return to conducting the agricultural operation (including conduct of the agricultural and conduct of the remedial action concurrently). The interventional control module implements the remedial actions, for instance with one or more of the vehicle or implement actuators 212, 216, to address identified operation disturbances.

The agricultural implement 204 in this example includes one or more sprayer booms extending from the agricultural vehicle 202. The agricultural implement includes its own implement sensors 214 and implement actuators 216. The implement sensors 214 include one or more sensors that permit autonomous agricultural operation, driver assisted operation (e.g., semi-autonomous), or driver operation. The implement sensors 214 are, in some examples, similar to sensors 210 provided with the agricultural vehicle 202. Optionally, the implement sensors 214 are oriented in different directions, for instance to observe different zones, targets or the like such as forthcoming crops, crops proximate one or more spray nozzles, spray profiles emanating from spray nozzles, wetting of crops (e.g., rearward directed sensors), soil or ground level, or boom height. The implement sensors 214 include one or more of visual, video, laser, radar, LiDAR, or ultrasound sensors, for instance to monitor the implement, performance of the implement, conditions around the implement (including to the sides, in front, behind or beneath the implement). In other examples, the implement sensors 214 include pressure sensors, flow meters, cameras or video cameras to monitor crops spray profiles or both; flow of agricultural product (e.g., fertilizer, herbicide, pesticide, water) or the like. Optionally, implement sensors 214 include load cells, sensors associated with actuators to monitor actuator characteristics or the like, for instance boom position, position of boom segments, for instance with articulating booms, or the like.

In still other examples, the implement sensors 214 include radio-frequency identification (RFID), short range radio frequency, infrared, temperature, encoder (position of booms, boom heights or the like), moisture, hyperspectral (NDVI) sensors or the like. Optionally, the implement 204 includes one or more positions sensors including, but not limited to, GPS, RTK sensors or the like.

The sprayer implement 204 (e.g., booms, boom chassis or the like) further includes implement actuators 216 to control the operation of the implement 204 while conducting an autonomous operation. The implement actuators 216 include actuators that control one or more of boom height, boom articulation, boom chassis suspension characteristics (damping, force or the like). In some examples, hydraulic, pneumatic or electromechanical systems control the various features of the implement 204. Accordingly, the implement actuators 216 include one or more of pumps, motors, control valves or similar that control one or more of hydraulic oil pressure or hydraulic oil flow rate for boom height control, boom articulation of multi-segment booms or the like. Optionally, with pneumatic or electromechanical systems pneumatic pumps, control valves, stepper motors, or servo motors are provided as actuators 216.

In other examples, the implement 204 includes actuators 216 such as one or more agricultural product pumps, control valves, modulating nozzles or the like to permit the controlled application of agricultural products like sprayed fertilizer, herbicide, pesticide, fungicide, including combinations of the like. The implement actuators 216 control flow rates, duty cycles, pressure, droplet size and spray profiles and optionally one or more of concentration or composition of the agricultural product. For instance, one or more of control valves and pumps control flow rates and pressure, and modulating control valves and modulating nozzles associated with spray nozzles control localized flow rates, droplet size (as a function of flow rate and pressure) at the spray nozzles.

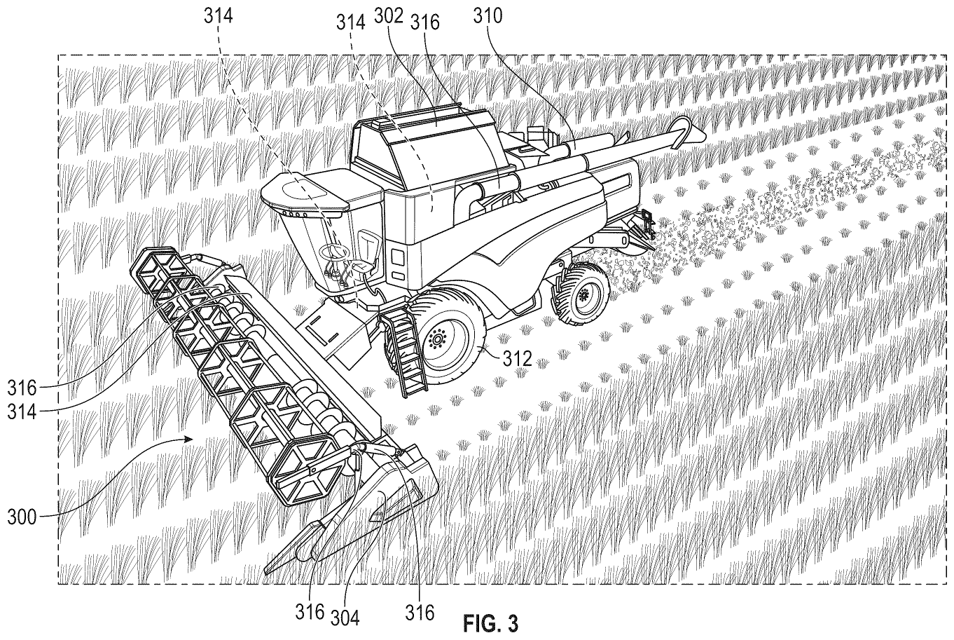

FIG. 3 is a perspective view of one example of an agricultural assembly 300 including a combine or harvester (used interchangeably herein) as the agricultural vehicle 302 and a harvester head as the implement 304. The agricultural implement 304 includes, in this example, is a harvester head and includes implement tools that provide one or more reaping, threshing, gathering or winnowing functions. As described herein, the agricultural implement includes tools and associated implements, such as, knives, cutter bar, scrapers, saws, drums, rollers, augers or the like.

The vehicle sensors 310 and vehicle actuators 312 of the agricultural vehicle 302 are similar in some regards to sensors and actuators provided with other vehicles, such as the agricultural vehicles 102, 202. In other regards the vehicle sensors 310 and vehicle actuators 312 are varied based on the type of agricultural vehicle, manufacturer, model, model year or the like. The vehicle sensors 310 include one or more sensors that permit autonomous agricultural operation, driver assisted operation (e.g., semi-autonomous), or human driver operation. Example vehicle sensors 310 include, but are not limited to, one or more of visual, video, laser, radar, LiDAR, ultrasound, sensors or the like to conduct observations proximate to or directed away from the agricultural vehicle 302. For instance, the vehicle sensors 310 in this example facilitate observation based steering, obstacle detection or the like. In other examples, the vehicle sensors 310 permit observation of crops, such as forthcoming crops, crops proximate to the harvester head (agricultural implement 304) or the like to facilitate precision harvesting including, but not limited to, harvesting crop rows, swaths or the like. With regard to the agricultural vehicle 302 in some examples sensors (e.g., radar, ultrasound or LiDAR) are directed toward crop edges (e.g., an unharvested edge of a crop swath, rows or the like) to identify the edge of unharvested crops and facilitate positioning of the harvester head relative to the edge.

The autonomous driver systems described herein, in an example, interface with the vehicle sensors 310 to permit the sensing and identification of operation disturbances. In other examples, the vehicle sensors 310 permit observation of remedial actions controlled by the autonomous driver systems to address and assess those remedial actions relative to operation disturbances (e.g., to assess successful or unsuccessful remediation).

Other example vehicle sensors 310 include, but not are not limited to, torque, speed, acceleration, inertial measurement unit (IMU), tachometer, dynamometer sensors or the like to monitor performance of the vehicle 302. The agricultural vehicle 302 includes vehicle sensors 310, such as position sensors, including one or more of a global positioning system (GPS) or real-time kinematic (RTK) sensors to monitor the position of the agricultural vehicle 302 (and implement 304). Additional vehicle sensors optionally include load cells, radiofrequency identification (RFID), short range radio frequency, infrared, temperature, encoders (e.g., header position), or the like.

The agricultural vehicle 302 includes various actuators 312 to permit movement, including navigation between crop rows, towing of implements, powering and control of implements including hydraulic and mechanical interfaces (e.g., clutches, drivetrains or the like). The vehicle actuators 312 include motor or engine associated actuators, such as throttle, brake, transmission, clutches, centrifugal clutches, variable speed pulley actuators or steering actuators. In other examples, the vehicle actuators 312 include hydraulic pumps, motors or the like and actuators for controlling hydraulic pressure and hydraulic flow rate. Example actuators includes hydraulic valves, hydraulic cylinders or control valves.

As provided herein, the autonomous driver system includes sensor and function interfaces to provide communication of sensor measurements, observations or signals to the autonomous driving controller having the agricultural operation module and the interventional control module discussed herein. For example, the autonomous driver system cooperates with existing sensors 310 of the vehicle (and implement sensors 314) to recognize operation disturbances (with the sensors), select remedial actions, and implement the remedial actions with actuators 312, 316 as described herein autonomously, and then return to conducting the agricultural operation (including conduct of the agricultural and conduct of the remedial action concurrently). The interventional control module implements the remedial actions, for instance with one or more of the vehicle or implement actuators 312, 316, to address identified operation disturbances.

The agricultural implement 304 in this example includes a harvester head coupled with the agricultural vehicle 302. In some examples, the agricultural implement 304 includes its own implement sensors 314 and implement actuators 316. The implement sensors 314 include one or more sensors that permit autonomous agricultural operation, driver assisted operation (e.g., semi-autonomous), or driver operation of the implement. The implement sensors 314 are, in some examples, similar to sensors 310 provided with the agricultural vehicle 302. Optionally, the implement sensors 214 are oriented in different directions, for instance to observe different zones, targets or the like such as forthcoming crops, observe crops with higher fidelity, crops proximate to portions or sections of the harvester head, soil or ground level, or header height or header orientation. The implement sensors 314 include one or more of visual, video, laser, radar, LiDAR, or ultrasound sensors, for instance to monitor the implement, performance of the implement, conditions around the implement (including to the sides, in front, behind, beneath or within the implement). In other examples, the implement sensors 314 include pressure sensors, granular flow meters, yield monitors, cameras or video cameras to monitor harvested crops within the harvester head as well as the augers, grain bin or the like (collectively the implement). In additional examples, the implements sensors 314 monitor performance, such as speed, rotations per minute or the like of cutter bars, saws, drums, rollers, augers or the like. Optionally, implement sensors 314 include load cells, sensors associated with actuators to monitor actuator characteristics or the like, for instance harvester head position, orientation or the like.

In still other examples, the implement sensors 314 include radio-frequency identification (RFID), short range radio frequency, infrared, temperature, encoder (position of booms, boom heights or the like), moisture, hyperspectral (NDVI) sensors or the like. Optionally, the implement 304 includes one or more positions sensors including, but not limited to, GPS, RTK sensors or the like.

The harvester head implement 304 (and associated portions that conduct combine functions, including augers, conveyors and grain bins or the like)) further includes implement actuators 316 to control the operation of the implement 304 while conducting an autonomous operation. The implement actuators 316 include actuators that control one or more of header height, header orientation; knife, cutter bar, scraper or saw function (e.g., speed, power); drum, roller, auger, conveyor speed; or the like. In some examples, hydraulic, pneumatic or electromechanical systems control the various features of the implement 304. Accordingly, the implement actuators 316 include one or more of pumps, motors, control valves or similar that control one or more of hydraulic oil pressure or hydraulic oil flow rate for header height or orientation control, speed or power of implement tools such as the knives, cutter bars, drums, rollers, augers or the like. Optionally, with pneumatic or electromechanical systems pneumatic pumps, control valves, stepper motors, or servo motors are provided as actuators 316.

FIG. 4 is a schematic view of one example of an agricultural vehicle control architecture 400. The architecture 400 is provided in a one or more processors having associated memory, input and output devices or the like. In this example, the architecture 400 is associated with a tractor as the agricultural vehicle and includes an autonomous vehicle controller 402. The autonomous vehicle controller 402 conducts the autonomous operation of the agricultural vehicle, such as the vehicles 102, 202, 302 described herein. For instance, the autonomous vehicle controller 402 interfaces with the vehicle sensors 406 and vehicle actuators 408. The vehicle actuators 408 include, but are not limited to, actuators discussed herein such as engine actuators, brake actuators, steering actuators (also referred to as engine controls, brake controls, and so on). Similarly, the vehicle sensors 406 include, but are not limited to, vehicles sensors discussed herein, such as object optical, video, radar, LiDAR, ultrasound, GPS, RTK, IMU, accelerometer, engine, brake and steering sensors.

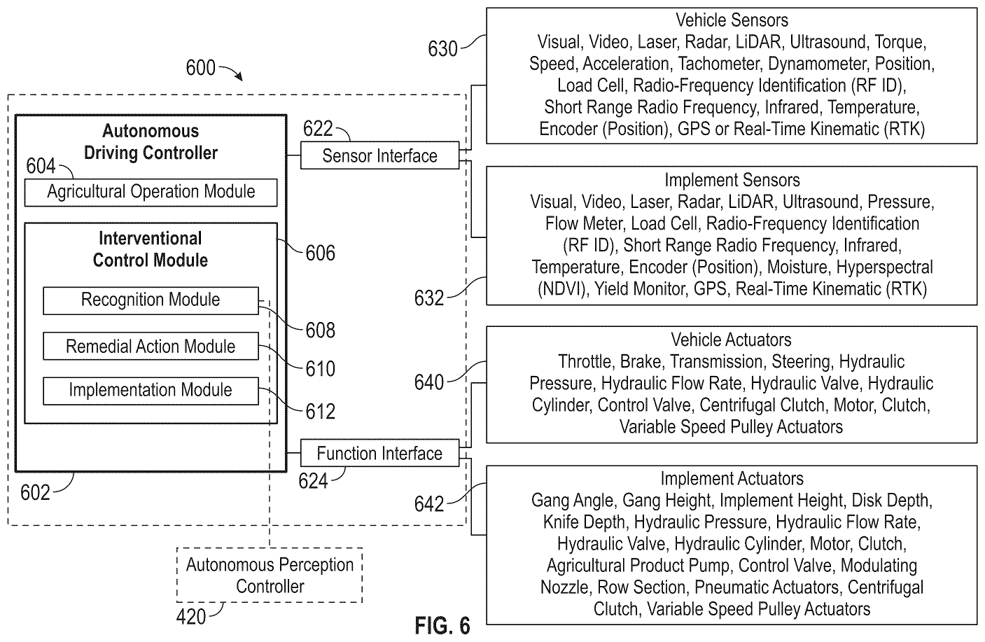

The autonomous vehicle controller 402 receives information from the various vehicle sensors 406 and provides instructions to the vehicle actuators 408 for the driving components of an autonomous agricultural operation. In another example, the autonomous vehicle controller 402 controls the vehicle 402 (e.g., actuator 408) based on remedial action(s) provided by the autonomous driving controller described herein. In one example a machine control module (MCM) is a component of the controller 402 and provides instructions for autonomous operation of the vehicle as well as autonomous conduct of remedial actions. Optionally, the autonomous driving controller 602 shown in FIG. 6 is a component of the MCM. In another option, the MCM receives autonomy instructions from the controller 602 and generates granular control instructions for the vehicle actuators 408. In another example, the autonomous vehicle controller 402 includes a universal control module (UCM) that controls the granular functions of the vehicle. For instance, granular instructions for throttle, steering, gear or the like are received from the MCM by the UCM and translated into control signals that operate the various actuators to conduct the specified autonomous operation (e.g., cause opening or closing of the throttle, steering angle change, change in gear, change in hydraulic pressure). In another example, the UCM is the interface between a human operator and the actuators 408 of the vehicle. For instance, pedal depression, steering wheel rotation, gear shifting of the like are translated into drive by wire instructions by the UCM for actuation of the associated actuators 408.

Referring again to FIG. 4, in one example a controller is included having a priority greater than the autonomous vehicle controller 402. This controller is referred to herein as a high level controller 430 or HLC. The high level controller provides priority control of the vehicle and (optionally) the implement, for instance in emergent situations that may warrant overriding of autonomous operation. As one example, the HLC 430 overrides autonomous operations and automatically halts the vehicle system in a situation including observation of a human within a planned path of the vehicle system. In another example, the HLC 430 has the highest priority with regard to implementation of remedial actions as discussed herein. For instance, on an occasion that the HLC 430 and one or more of the autonomous vehicle controller 402 or implement controller 404 attempt to implement respective remedial actions, the remedial action(s) of the HLC 430 have the higher priority and are conducted first.

As shown in FIG. 4, one or more vehicle sensors 406, such as an object detection radar, or similar sensors such as optical, video, LiDAR or the like are routed through an autonomous perception controller 420 that is in turn in communication with the HLC 430. The connection of the HLC 430 to the autonomous perception controller 420 ensures the HLC 430 receives object detection and identification information (e.g., identified and indexed humans, livestock or the like) immediately without previous routing through the autonomous machine controller 402, implement controller 404 or the like. Instead, the HLC 430 is permitted to immediately act upon identified objects including arresting of agricultural assembly operation or designating an identified object as having a lower priority and passing the identified object to a guidance and navigation module 440 to conduct a refinement of a path plan to circumvent the obstacle.

As further described herein, the HLC 430 in one example includes the autonomous driving controller 602 (of the autonomous driver system 600, see FIG. 6) that provides one or both of direction for conduct of an autonomous operation with the agricultural operation module 604 or identification of operation disturbances and implementation of remedial actions with the interventional control module 606. Optionally, the autonomous driving controller 602 is a separate component of the agricultural vehicle architecture 400 (or distinct from the architecture and provided with a dedicated processor) that interfaces with one or more of the autonomous vehicle controller 402, autonomous implement controller 404, or other components of the architecture.

In other examples, the HLC 430 handles other autonomous functions alternatively or in addition to conduct of an autonomous agricultural operation. As previously discussed, the HLC 430 in one examples implements actions based on information from autonomous perception controller 420 with regard to obstacles (humans, livestock, water, rocks, fences or the like) including starting and stopping (beginning or arresting of operation), determining an obstacle is not interrupting the path of the agricultural assembly, determining the agricultural assembly may re-initiate (restart) autonomous operation.

In one example, the HLC 430 monitors the overall system, such as the architecture 400 including hardware and software components to ensure that all required firmware and software components are present and functioning correctly. In another example, the HLC 430 through the communication module 414, receives commands from a remote operator, for instance to start operation, stop operation, conduct a specified function (e.g., calibration, initialization or the like). Optionally, the HLC 430 in cooperation with the communication module 430 relays information to one or more of a remote operator or onboard field computer (e.g., display 412) including, but not limited to, sensor observations, video, machine status information, autonomous perception recognized obstacles or features, or mission status (conduct of operation, progress of the operation, speed or the like).

In another example, the HLC 430 includes the autonomous driving controller 602 shown in FIG. 6 and works with one or more of the vehicle and implements controllers 402, 404, their associated sensors or actuators to manage the autonomous operation as well as interventional operation with regard to identifying operation disturbances and implementing remedial actions.

Optionally, the HLC 430 generates path plans for ad hoc operations, such as grain cart routing, guidance or the like. In another example, the HLC 430 (with the communication module 414) receives preplanned mission path plans from a remote operator. In still another example, the HLC 430 with the guidance and navigation module 440 interprets a path plan and provides instructions to steering actuators 408. In another example, the HLC 430 provides propulsion instructions (speed, heading, power or the like) to the autonomous vehicle controller 402. For instance, instructions are provided to a machine control module (MCM) of the controller 402 that handles autonomous operation of the vehicle actuators 408, and the MCM generates granular autonomous instructions based on the HLC 430 instructions. The granular instructions include, but are not limited, transmission gear, throttle setting, steering angle, power apportionment or the like. These instructions are passed to a universal control module (UCM) of the controller 402 that translates the granular instructions into control signals for the respective actuators 408.

In another example, the HLC 430 provides autonomous operation instructions to the autonomous implement controller 404, and the controller 404 conducts actuation of the implement based on those instructions. The instructions include, but are not limited to instructions for autonomous operation, such as implement settings (including setting ranges), changes to implement settings, tool selections or the like. Additionally, instructions from the HLC 430 in another example include instructions for interventional control, for instance provided by the interventional control module of the autonomous driving controller 602.

Referring again to FIG. 4, the agricultural vehicle architecture 400 includes a guidance and navigation module 440. The guidance and navigation module 440 conducts one or more of path planning, path refinement (e.g., for identified obstacles), or delivery of path planning for implementing of autonomous operation of the agricultural vehicle, agricultural implement or both. The guidance and navigation module 440 is in communication (directly or indirectly) with vehicle sensors 406 including GPS, RTK sensors or the like that permit detection of location of the agricultural vehicle. In another example, the guidance and navigation module 440 is in communication with the autonomous driving controller 602. The autonomous driving controller 602 is a component of the HLC 430, another illustrated controller (e.g., the autonomous vehicle controller 402), or a separate component of the architecture 400. The agricultural operation module 604 of the controller 602 receives the path plan from the guidance and navigation module 440 and conducts the agricultural operation along the path plan including one or more of autonomous driving or autonomous implement operation by way of the respective controllers 402, 404 and associated vehicle actuators 408 or implement actuators (shown in FIG. 4 with the implement actuator interface 410).

In another example, the agricultural vehicle architecture 400 includes various input or output devices. The display 412 is one example of an output device and potential input device. Optionally, the display 412 is component of a field computer. For instance the display 412 includes a touch screen, keyboard or the like that outputs vehicle and implement status; agricultural operation progress and status; agricultural assembly position, heading, speed or the like; indications of operation disturbances identified with the interventional control module 606 (described herein and shown in FIG. 6) and remedial actions implemented with the module 606. In other examples, the display 412 permits the input of refinements to an autonomous operation, initiation of driver operation of the agricultural assembly, and initiation of autonomous operation. As described herein, the display 412 in another example provides operator queries and permits input of responses to the queries to facilitate building out of an agronomy tree of operation disturbances and associated remedial actions for the interventional control module 606 of the autonomous driving controller 602.

The agricultural vehicle architecture 400 includes, in another example, a communication interface 414. The communication interface 414 facilitates communication between agricultural vehicles, implements, cloud based systems, cellular network, radio, wifi or the like. For instance, operation, vehicle, implement statuses or the like are communicated to other vehicles, networks interconnecting vehicles or the like. Similarly, the communication interface 414 optionally receives similar information (e.g., status, such as position, operation progress, identified obstacles or the like) and provides the information to facilitate refined conduct of the autonomous operations of the vehicle and associated implement.

The agricultural vehicle architecture 400 further includes an autonomous perception controller 420, and the controller 420 is in turn in communication with one or more of the vehicle sensors 406 (and optionally implement sensors). The vehicle sensors 406 include, but are not limited to, optical, video, radar, ultrasound, LiDAR sensors or the like that permit the observation of obstacles and operation disturbances (e.g., for the interventional control module 606).

The autonomous perception controller 420 identifies obstacles, operation disturbances (in some instances obstacle disturbances include obstacles) or the like from one or more of a vehicle sensor 406, implement sensor or the like. In one example, the controller 420 includes an agronomy tree populated with operation disturbance designations and profiles, such as a log of obstacles and operation disturbances, stock images for the same, thresholds for identification of obstacles and operation disturbances, algorithms for identifying obstacles and operation disturbances from the stock images or the like, to conduct identification of obstacles and operation disturbances observed with the sensors.

In another example, the controller 420 includes communicates with machine learning or AI modules to conduct identification of obstacles or operation disturbances. In the context of the interventional control module 606 of FIG. 6, the recognition module shown therein includes or accesses machine learning or AI modules to identify operation disturbances (including obstacles). Remedial actions for the identified operation disturbances are selected from an associated branch of an agronomy tree.

The machine learning or AI modules are in various examples one or more layers or techniques of artificial intelligence applied to assist in various aspects of identifying obstacles, operation disturbances or the like. The machine learning or AI modules analyze images and reflected signals from one or more of the vehicle or implement sensors to detect and classify the objects in the fields of view of the sensors. Additionally, these artificial intelligence techniques may be used to evaluate a vehicular state (position, GPS or RTK position, speed, heading, yaw-rate, turning radius, distance, implement status or the like) for controlling one or more of position, speed, heading or acceleration of the vehicle, or operation of the implement in response to identified obstacles, operation disturbances or the like.

Artificial intelligence and other types of machine learning are associated with the autonomous perception controller 420 to associate and compare information from various types of sensor data, and to identify attributes in the sensor data to produce detections of objects and operation disturbances, changes in detected objects and operation disturbances (movement, decrease or increase of severity or the like), and optionally to predict changes of those detected objects. Artificial intelligence associated with the autonomous perception controller 420 may include one or more neural networks configured to develop relationships among and between the information within the various types of sensor data to recognize objects across images and reflected signals from different types of sensors having different fields of view. As discussed herein, the identified operation disturbances (that may include obstacles, variations from specified operation, failure, indications of failure or the like) are used to determine and select remedial actions for implementation with one or more of the agricultural machine or vehicle. Artificial intelligence is therefore optionally used in the autonomous perception controller 420 for identification and remediation of operation disturbances.

Different types of artificial intelligence may be employed singularly or cooperatively within the scope of the autonomous perception controller 420 and other portions of the architecture 400. These types of artificial intelligence may include techniques such as k-nearest neighbor (KNN), logistic regression, support vector machines or networks (SVM), and one or more neural networks as noted above, such as a convolutional neural network (CNN), a fully convolutional neural network (FCN), a Recurrent Neural Network (RNN), or Large Language Models (LLM) trained with image inputs.

Referring again to FIG. 4, an autonomous implement controller 404 is shown in communication with the remainder of the agricultural vehicle architecture 400. In one example, the autonomous implement controller 404 is a component of the agricultural implement, for instance provided onboard the implement and interfaced to the architecture with a data connection (e.g., wired, wireless or the like). In another example, the autonomous implement controller 404 is provided with the agricultural vehicle, and in one example is provided in one or more processors of the agricultural vehicle architecture 400 such as a field computer.

The autonomous implement controller 404 provides autonomous instructions to an implement associated with the agricultural assembly of the agricultural vehicle and the agricultural implement for conduct of the agricultural operation. The autonomous control includes, but is not limited to, spraying operations, tilling operations, harvesting, cultivating, mowing or the like. An implement actuator interface 410 is in communication with the controller 404 and relays instructions to the various components of the agricultural implement. In a tilling example, the controller 404 and interface 410 provide instructions to the agricultural implement, a tiller implement, for implementation of the autonomous agricultural operation. The instructions in this example include, but are not limited to, component functions of the operation (e.g., depth control, gang angle, implement height for tilling; flow rate, pressure, spray profile, mowing speed, harvesting operation for other operations or the like). In another example, the autonomous implement controller 404 and the interface provide instructions for the control of the agricultural implement to implement one or more remedial actions provided by the autonomous driving controller described herein.

The controllers described herein, such as the autonomous vehicle and implement controllers 402, 404, high level controller (HLC) 430 or the like are provided with relative priorities. For instance, the autonomous vehicle controller 402 is a middle priority controller positioned above the various actuators 408 and the autonomous implement controller 404, and below a higher priority controller, such as the HLC 430. In an example the autonomous vehicle controller 402 (or implement controller 404) is selectively overridden or has its control instructions refined by the HLC 430. For instance, in a circumstance including identification of a human along a planned path of the agricultural assembly the HLC 430 overrides conduct of the autonomous operation with the autonomous machine controller 402, and instead arrests operation. In another example, the autonomous vehicle controller 402 has a higher priority than the autonomous implement controller 404 and the vehicle controller 402 selectively overrides the implement controller 404, for instance with identification of an obstacle in front of the vehicle that exceeds a threshold for causing damage to either or both of the vehicle or implement. In still another example, a component controller of the autonomous vehicle controller such as a machine control module (MCM) for controlling autonomous operation has a higher priority than a universal control module (UCM) for controlling granular function of the vehicle.

The architecture 400 shown in FIG. 4, in another example, is arranged with an edge computing variation. In this variation, the HLC 430 is provided as a higher priority controller, the autonomous vehicle controller 402 is provided at middle priority, and the autonomous implement controller 404 is a lower priority controller. The controllers are optionally interconnected in a stacked configuration, HLC 430 to controller 402 to actuators 408. In this variation the autonomous perception controller 420 is coupled with each of the controllers 430, 402 (404) and actuators 408 in an edge manner. For instance, instead of indirect connection in series the autonomous perception controller 420 is coupled with each of the HLC 430, controllers 402, 404, and the autonomous driving controller 602 (if separate from the other controllers) in a direct manner (e.g., without intervening controllers). The edge computing architecture provides immediate and direct access to the autonomous perception controller 420 for the identification of operation disturbances (including obstacles) on an as-needed basis for each of the controllers. Optionally, access is staggered according to priority with the HLC 430 having higher priority access than lower priority controllers.

FIG. 5 is a schematic view of one example of an agricultural implement architecture 500. In this example, the architecture 500 is for a tillage implement. The architecture 500 includes at least one agricultural implement controller 502 (e.g., a processor, one or more processors or the like) interconnected with implement sensors 506, and configured to control components of the implement including implement actuators 508. The at least one agricultural implement controller 502 corresponds in an example to the implement controller 404 shown in FIG. 4. The architecture 500 includes an interface 510 that interconnects the implement with the remainder of the agricultural assembly, such as the agricultural implement and its architecture 400 shown in FIG. 4. The interface 510 includes, but is not limited to, a wireless connection (e.g., wifi, cellular, radio or the like) or a wired connection (CAN, BUS or the like).

Referring again to FIG. 5, the example agricultural implement architecture 500 includes one or more controllers. In this example, the architecture 500 includes implement controllers 502, 503, 504. The controllers are interconnected with sensors 506 and actuators 508. The autonomous implement controller 502 provides instructions to the implement actuators 508 for controlling the implement actuators during agricultural operation. In another example, the autonomous implement controller 502 controls the implement (e.g., a tillage implement) to conduct one or more remedial actions provided by the autonomous driving controller 602 (FIG. 6). Optionally, the autonomous implement controller 502 (as well as controllers 503, 504) is a lower priority controller that may be over-ridden or have its control instructions refined by the HLC 430 or autonomous vehicle controller 402, as well as the autonomous driving controller 602. As described herein, the autonomous driving controller 602 is a component of the HLC 430, autonomous vehicle controller 402 or is a separate controller provided with the architecture 400.

As shown in FIG. 5, the autonomous implement controller 502 in this example is directly interconnected with implement sensors 506 including a blockage monitoring sensors (e.g., optical, video sensors, accelerometers or the like) configured to detect blockage of one or more of the implement tools. The controller 502 is also connected with another implement sensor 506 for monitoring gang angle of the tillage implement relative to forward travel or forward to back axis of the implement.

Additional implement controllers 503, 504 are shown in FIG. 5. In another example, these controllers 503, 504 are consolidated with the implement controller 502. The implement controller 504 is interconnected with one or more implement sensors 506, as shown in FIG. 5, a crumbler monitor sensor and surface monitor sensors. These sensors monitor tilling and the associated soil, for instance to assess agglomeration (clods), saturation of the soil or the like (collectively referred to as surface finish). In an example, the observed clodding, saturation or the like is an operation disturbance that is identified and the autonomous driving controller 602 implements one or more remedial actions including elevation (decrease of depth) of the knives or disks, change of gang angle, elevation of the tillage implement or the like.

The implement controller 503 is in communication with one or more implement actuators 508. In the example tillage implement the actuators include, but are not limited to, actuators for depth control, gang angle and wing control (e.g., hydraulic cylinders, motors or the like). Depth control actuators control the depth of the implement tools (knives, disks or the like) in the soil. Gang angle actuators control the angle of the implement tools relative to forward travel or the longitudinal axis of the implement. The wing control actuators control lifting and lowering of the implement including wings having the implement tools. The functions of these actuators are controlled during conduct of the agricultural operation and while taking remedial actions according to instructions from the autonomous driving controller 602.

In one example, the agricultural implement including one or more of the controllers 502, 503, 504 implements an autonomous agricultural operation as part of the agricultural assembly of the vehicle and the implement. Upon identification of an operation disturbance, such as such as slippage, power draw or the like of the agricultural vehicle, the autonomous driving controller 602 may override or refine the agricultural operation control at one or more of the implement controllers 502, 503, 504 of one or more of the implement actuators 508 as part of implementing a remedial action associated with the operation disturbance. In other examples, the HLC 430 (high level controller) may provide a higher priority control upon identification of a higher priority operation disturbance such as, a human or livestock proximate to or in the path of the assembly, to stop agricultural assembly movement or operation, slow down movement or operation or the like.

FIG. 6 is a schematic view of one example of an autonomous driver system 600 including an autonomous driving controller 602 having an agricultural operation module 604 for implementing an autonomous operation including autonomous driving and implement operation of an agricultural assembly having a vehicle and agricultural implement, such as the examples shown in FIGS. 1-3. The autonomous driver system 600 further includes an interventional control module 606 that provides additional autonomous adaptability approaching that of a human driver recognizing operation disturbances and implementing remedial actions to address the disturbances. As discussed herein the interventional control module 606 includes or has access to an agronomy tree having one or more branches for operation disturbances and associated remedial actions. The components of the interventional control module 606 access the agronomy tree to identify operation disturbances from observations made with vehicle and implement sensors and then selectively implement remedial actions to address the identified operation disturbances, for instance with one or more of the vehicle actuators or implement actuators.

As shown in FIG. 6, the autonomous driving controller 602 is interconnected with one or more vehicle or implement sensors 630, 632 and vehicle or implement actuators 640, 642. In FIG. 6, a sensor interface 622 (e.g., BUS, CAN BUS or the like) interconnects the controller 602 with the sensors 630, 632. Similarly, a function interface 624 interconnects the controller 602 with the actuators 640, 642. In one example the interfaces 622, 624 are relatively direct, for instance made with one or more BUSes, wiring, cables or the like. In other examples, the interfaces 622, 624 are indirect. For instance, in FIG. 4 and as previously described herein, the autonomous driving controller 602 is provided with one or more of the HLC 430, autonomous vehicle controller 402, or is provided as a separate controller in the agricultural vehicle architecture. In this example, the autonomous driving controller 602 and its interfaces to the sensors and actuators are provided with the architecture 400, such as through the various interconnections, BUSes, CAN BUSes or the like provided with the architecture. The controllers described herein, including the autonomous driving controller 602, are provided in one or more processors, associated memories or the like including one or more memories storing instructions that, when executed by the one or more processors, cause the one or more processors to perform the functions described herein.

The vehicle and implement sensors 630, 632 and vehicle and implement actuators 640, 642 shown in FIG. 6 are examples. The various sensors and actuators provide a non-exclusive list of sensors and actuators accessible with the autonomous driving controller 602. Additional examples are described herein, for instance with description of the various agricultural vehicles and implements, as well as equivalents.

The vehicle and implement sensors 630, 632 and vehicle and implement actuators 640, 642 facilitate the conduct of autonomous operation including driving, implement operations or the like. Additionally, the sensors 630, 632 facilitate the detection and identification of operation disturbances that are issues arising in the autonomous operation, autonomous driving or in a related portion of vehicle or implement operation (e.g., starting, initializing, ending of an operation, shutdown of the vehicle or implement or the like). As described herein the interventional control module 606 interprets sensor information and identifies operation disturbances based on a log or catalog of operation disturbances (e.g., in an agronomy tree), and potentially with use of an autonomous perception controller 420 (see also FIG. 4).

The vehicle and implement actuators 640, 642 facilitate the conduct and control of autonomous operation of the agricultural assembly (vehicle and implement). Additionally, the actuators 640, 642 implement remedial actions that address identified operation disturbances. After identification of the operation disturbance the interventional control module 606 selects one or more remedial actions, for instance from a branch of the agronomy tree having the operation disturbance, and implements the actions through vehicle or implement actuators configured to conduct those remedial actions.

Referring again to FIG. 6, the autonomous driver system 600 includes the autonomous driving controller 602 for implementation of autonomous agricultural operations, such as driving and operation of an implement of the agricultural assembly. In some examples, autonomous agricultural operations are based on templates for respective operations (e.g., provided with a tractor) that permit the input of field maps, vehicle settings, implement settings or the like for conduct of the autonomous operation.

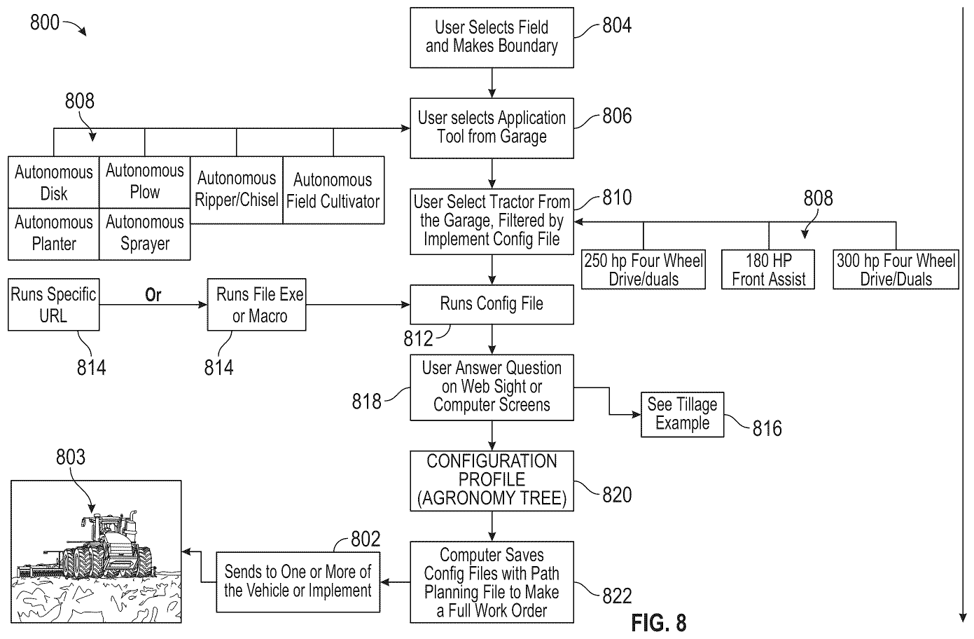

In other examples, for instance shown in FIG. 8, the autonomous driver system 600 includes one or more inputs for receipt of characteristic bundles for selected vehicles and implements. In this example, the autonomous driver system 600, instead of filling the template for the vehicle, assembles or builds a composite configuration profile of vehicle and implement sensors and actuators from those available with the selected vehicle and implement that can conduct the autonomous operation. The composite configuration profile includes vehicle and implements settings, determined from operator queries and the characteristic bundles, for conduct of the autonomous operation. The composite autonomous configuration profile is distinct from developer generated autonomy templates that are provided with vehicles and are irregularly updated (e.g., in firmware or software updates). Instead, the composite autonomous configuration profile is assembled and generated by the system 600 based on available sensors, actuators, controllers or the like with the vehicles. For instance, the configuration profile is more similar to a human operator that climbs into a vehicle cab, assesses the controls, sensors, and actuators available for the vehicle and attached implement, and then conducts the specified operation based on that assessment and knowhow. One example of the assembly of a composite autonomous configuration profile is provided in FIG. 8, and includes example steps for the generation of an agronomy tree for use with the interventional control module 606 including automated generation and query based generation of the tree.

Referring again to FIG. 6, the autonomous driving controller 602 includes an interventional control module 606 in addition to the agricultural operation module 604. In one example, each of the controllers 604, 606 are components of an overall controller. In another example, the controllers 604, 606 are distinct from each other. The interventional control module 606 assesses sensor input to recognize (identify) operation disturbances and provide remedial actions to address the recognized operation disturbances. The operation disturbances include variations in performance of the agricultural assembly that are related or unrelated to driving and conducting the operation (e.g., the disturbances may relate to start up, initialization, conduct of the operation, transport, shut down, maintenance issues or the like). As described herein, the interventional control module 606 provides a simulated driver or operator (e.g., virtual, approximate or the like) that addresses various issues that arise during operation of the agricultural assembly that fall outside of specified conduct of the agricultural operation or other autonomous functions of the agricultural assembly, such as but not limited to, start up, initialization, conduct of the operation, transport, shut down, maintenance issues or the like.

The interventional control module 606 includes submodules 608, 610, 612 that perform one or more functions related to identification of operation disturbances and implementation of remedial actions for identified operation disturbances. The submodules are optionally consolidated or distinct, for instance associated with one or more distinct processors, memories or the like including memories storing instructions that, when executed by one or more processors, cause the one or more processors to perform the functions of identification operation disturbances and implementation of remedial actions to address those disturbances.

As shown in FIG. 6, the interventional control module 606 includes a recognition module 608 that recognizes (detects and identifies) operation disturbances that vary from the specified conduct of an agricultural operation, such as guidance of the assembly along rows and swaths, operation of an associated implement to conduct the operation as well as functions of the assembly unrelated to the conduct of the operation. The recognition module 608 assesses information from sensors (e.g., images, video, reflected signals, signals indicative of one or more characteristics such as flow, pressure, position, speed or the like) and identifies operation disturbances based on the assessments.

In some examples, information from multiple sensors is analyzed with the recognition module 608. As shown in FIG. 6, a plurality of vehicle sensors 630, 632 are provided for input to the autonomous driving controller 602 having the recognition module 610. One or more of these sensors 630, 632 provide sensed information that are indicative of various operation disturbances while optionally provide sensed information related to conduct of the autonomous agricultural operation.

Optionally, the recognition module 608 includes or is in communication with the autonomous perception controller 420 described herein to facilitate the assessment of sensor information. For instance, the autonomous perception controller 420 facilitates the identification of learned features from sensor information, such as images, video, reflected signals or the like. In other examples, the agronomy tree includes operation disturbances as branches of the tree, and each of the branches includes thresholds, tags for AI recognized features (e.g., from AI learned features) or the like to permit recognition of operation disturbances from the one or more sensor inputs. Sensor information (signals) that satisfies thresholds, comports with a tagged AI recognized feature or the like is indicative of an associated operation disturbance. In some examples, combinations of sensor information that satisfies thresholds or comports with AI recognized features indicate an operation disturbance when occurring in combination.

In one example, an operation disturbance for slippage of one or more ground engaging elements (tires, tracks or the like) is provided as a branch of an example agronomy tree. In this example, vehicle sensors 630 including one or both of visual or video sensors directed at the ground engaging elements communicate with the interventional control module 606. In another example, one or more of a speedometer, tachometer, torque sensor or the like communicates with the interventional control module 606. Optionally, implement sensors 632 such as visual or video sensors directed at the forward portions of the implement also have views of rear grounding engaging elements of the agricultural vehicle. These sensors are, in this example, suited for detection of conditions related to slippage. In other examples, the interventional control module 606 is in communication with all or a designated subset of the sensors 630, 632 to permit the detection and identification of various different operation disturbances (e.g., implement blockage, flat tires, fouled sprayer nozzles or the like) in an ongoing manner.

As previously described, the autonomous driving controller 602 is in communication with one or more of an agronomy tree or the autonomous perception controller 420. The recognition module 608 reviews the agronomy tree branches and selects operation disturbances (identifies disturbances) based on a correlation between the sensor measurements indicating disturbance characteristics and one or more of disturbance thresholds, tags for AI recognized features (e.g., slippage, soil scattering or the like) or the like. In one example, the autonomous perception controller 420 facilitates the identification of slippage from sensor information, such as the images, video, torque, speed measurements or the like. For instance, the recognition module 608 in cooperation with the controller 420 identifies slippage from a combination of related signals indicative of slippage from the sensors 630, 632. The signals indicate one or more disturbance characteristics including, but not limited to, soil or mud scattering; increased engine noise, rpms or the like without commensurate positional changes. In another example, the recognition module accesses disturbance thresholds associated with slippage (e.g., torque, speed or the like as disturbance characteristics) provided in the agronomy tree branch to conducts comparisons with sensed disturbance characteristics to identify a slippage operation disturbance.

In another example, the recognition module conducts both threshold comparisons between sensor measurements (e.g., disturbance characteristics compared with disturbance thresholds) and recognition of slippage with the autonomous perception controller 420 in combination to provide enhanced confidence of identification of the slippage operation disturbance. For instance, the recognition module assigns unitless quantities (numbers) to threshold comparisons and perception controller recognition for slippage and scales the quantities based on confidence of identification with the associated sensor, and adds the quantities together. The recognition module 608 compares the summed quantity with an identification threshold (including ranges of thresholds corresponding to escalating confidence values) to identify the composite sensor observations as an operation disturbance, for instance with a confidence value of 60, 70, 80, 90, 95 percent confidence that slippage is identified. The recognition module 608 thereby recognizes, or identifies, operation disturbances and provides a designation of that operation disturbance to facilitate selection of a remedial action (or actions).

The interventional control module 606 selects one or more remedial actions based on the identified operation disturbance (or disturbances). As shown in FIG. 6, the module 606 includes a remedial action module 610. The remedial action module 610 selects one or more remedial actions based on the identified obstacle disturbance. Optionally, as discussed herein the selected remedial action includes a series of remedial actions that are conducted in parallel, in series or the like while the recognition module 608 continues to observe the operation disturbance and evaluate the disturbance as it is addressed (e.g., to arrest application of the remedial action).

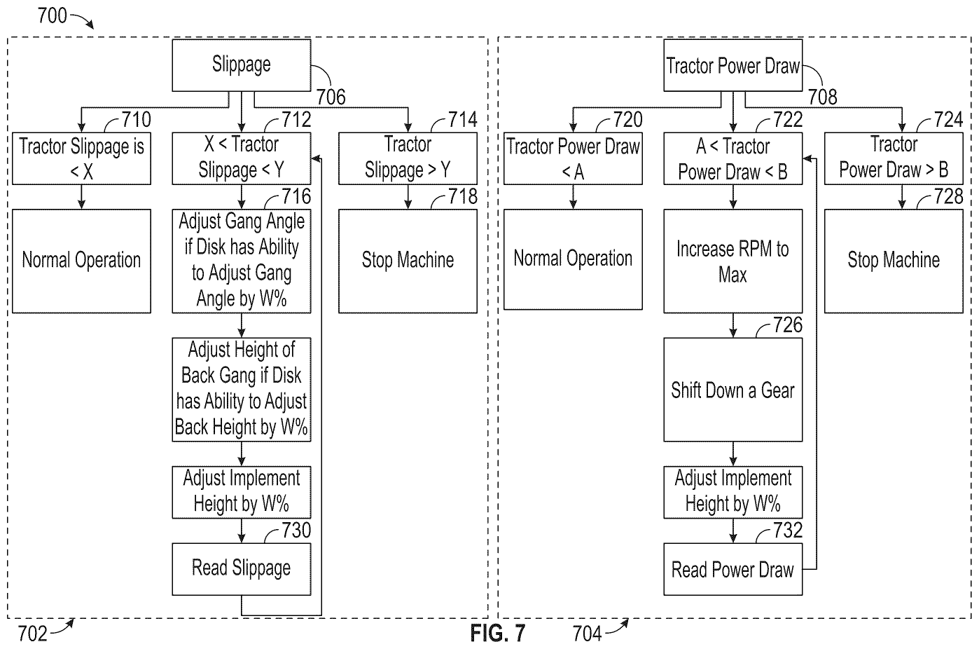

In one example, the remedial action module 610 accesses the agronomy tree having branches for various operation disturbances. The module 610 consults the branch for the identified operation disturbance and selects one or more remedial actions associated with the disturbance branch. In an operation disturbance branch having multiple remedial actions the actions are optionally assigned priorities, an order or the like and the remedial action module accordingly selects the remedial actions based on the specified priority or order. As shown in FIG. 7, in one example, the remedial actions are selected based on a relative degree of the operation disturbance, such as slippage less than or equal to a first disturbance threshold, greater than a second disturbance threshold. In other examples, multiple operation disturbances are identified. As shown in FIG. 7, two examples of operation disturbances including slippage and tractor power draw are both identified. In this example, the remedial action 610 consults the associated branches of the agronomy tree for each disturbance and selects associated remedies for each.

The interventional control module 606 further includes an implementation module 610 to conduct the selected remedial actions. As shown in FIG. 6, the autonomous driving controller 602 having the implement module 612 is in communication with vehicle and implement actuators 640, 642 by way of the function interface 624. The remedial actions selected with the remedial action module 610 are implemented by the implementation module 612 with one or more of the actuators 640, 642.

In one example, the agronomy tree of operation disturbances and associate remedial actions includes prescriptions for conduct of the remedial actions. FIG. 7 provides examples of remedial actions and their prescriptions. For instance, for identified tractor slippage between X and Y with a connected tillage implement, gang angle of the implement is first adjusted by a percentage (e.g., 5 percent, 2 degrees or the like), followed by adjustment of the height of the back gang of the implement by a percentage (e.g., elevations of 10 percent, 3 inches or the like). Optionally, the interventional control module 606 continues to monitor for slippage with the sensors 630, 632. Upon monitoring of continued slippage after an initial remedial action (e.g., change of gang angle) the implementation module 612 escalates the remedial action prescription, for instance by conducting adjustment of the back gang height. In contrast, if slippage falls below thresholds, slippage is not identified with the perception controller 420 or the like the remedial action is optionally arrested.

Optionally, the interventional control module prioritizes the conduct of remedial actions. In one example, the interventional control module 606 overrides the conduct of the agricultural operation (depending on the operation disturbance, remedy) to implement the selected one or more remedial actions. In another example, the module 606 permits the continued conduct of the agricultural operation while also implementing the remedial action(s), for instance if possible to conduct the operation and remedial action at the same time.

FIG. 7 is a schematic example an agronomic tree 700 and two branches 702, 704 for ground engagement slippage and tractor power draw. The branches 702, 704 include the operation disturbance, for instance identified with eh recognition module 608 with one or more threshold comparisons, AI based sensor signal comparisons with the autonomous perception controller 420 or the like. The branches 702, 704 include the operation disturbance designations (e.g., slippage or tractor power draw). In the examples shown, each of the branches 702, 704 include sub-branches, and associated remedial actions that when implemented by way of the implementation module 612 and the various vehicle or implement actuators 640, 642 address and improve (including curing) the identified operation disturbances.

Referring first to branch 702 for the slippage designation 706, the branch 702 includes sub-branches 710, 712, 714 corresponding to various degrees of slippage. The sub-branch 710 corresponds to an identified tractor slippage less than or equal to a first threshold (X), such as a percentage or quantity of slippage. In this example slippage at or below this threshold (X) includes normal operation as the remedial action (e.g., the agricultural operation continues despite some amount of slippage). In another example, the branch 702 includes another sub-branch 712 for tractor slippage between two or more threshold values (X, Y) such as a first lower tractor slippage threshold (X) and a higher second tractor slippage threshold value (Y). In this example a plurality of remedial action 716 are provided including an escalating series of remedial actions including initially adjusting the gang angle of one or more disks of the tillage implement by a percentage for instance by 2 percent, 10 percent or the like. In another example the gang angle is adjusted by a specified number of degrees scaled based on the value of tractor slippage between the thresholds X and Y.

In one example slippage monitoring is continued during conduct of the remedial actions 716 for instance with the recognition module 608. In this example if slippage continues to increase or does not improve at a threshold value (provided with the sub-branch 712) the remedial actions 716 continue to escalate. For instance the height of the back gang of the tillage implement is increased by a value corresponding to a percentage of the depth of the implement tools within the soil, a specified height value or the like. Another example continued remedial action along this sub-branch 712 includes adjustment of the implement height for instance with an implement hydraulic cylinder configured to raise all of the implement tools or the like by a specified value or varied value scaling to the value of tractor slippage between the threshold values of X and Y. As shown in FIG. 7 the sub-branch 712 further includes monitoring of slippage, for instance with the recognition module 608 to determine if further remedial action 716 are needed.

As further shown in FIG. 7, the branch 702 for slippage includes another sub branch 714 corresponding to tractor slippage greater than or equal to a second threshold (Y). in this example another remedial action 718 is provided including stoppage of the machine (arresting of operation) or agricultural assembly to prevent further slippage of the agricultural assembly.

FIG. 7 includes another example of an agronomy tree branch 704 for a tractor power draw 708 operation disturbance. In this example the tractor power draw branch 704 includes multiple sub-branches 720, 722, 724. The sub-branches 720-724 are divided according to the quantity or value of tractor power draw. For example, the first sub-branch 720 includes tractor power draw at or below a first threshold value A, and includes as a remedial action conduct of normal operation, also referred to as no remedial action. In another example, tractor power draw between threshold values such as a first lower value A and a second higher value B includes one or more escalating remedial action 726 including, but not limited to, increasing engine speed (rpms) a maximum specified value for the agricultural vehicle, shifting to a lower gear, implementing height adjustment of an attached implement, such as a tillage implement, and conduct of further monitoring of the power draw operation disturbance at 732. In the example shown in FIG. 7, for instance along the sub-branches 712, 722, slippage and power draw are monitored at the conclusion of conduct of each of the remedial actions 716, 726.

In other examples monitoring of slippage or power draw 732 is conducted in an ongoing fashion. Assessment of slippage or power draw below specified values, for instance below the threshold value X for branch 702 or threshold value A for branch 704, arrests further conduct of remedial actions and accordingly returns operation of the agricultural assembly to the autonomous agricultural operation. This monitoring is conducted as the remedial actions 716, 726 are implemented, and accordingly the should slippage or power draw fall below the associated thresholds the escalating remedial actions are not performed.

As further shown in FIG. 7 the branch 704 for tractor power draw 708 further includes the sub-branch 724. In this example, tractor power draw greater than a second threshold value B causes stoppage of the machine and arresting of operation as the remedial action 728.

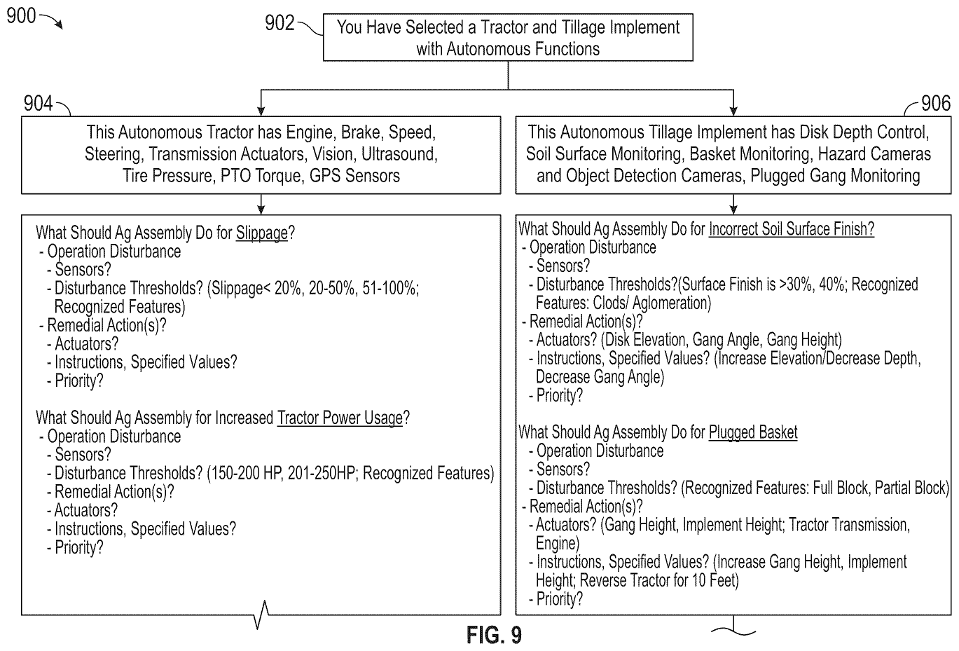

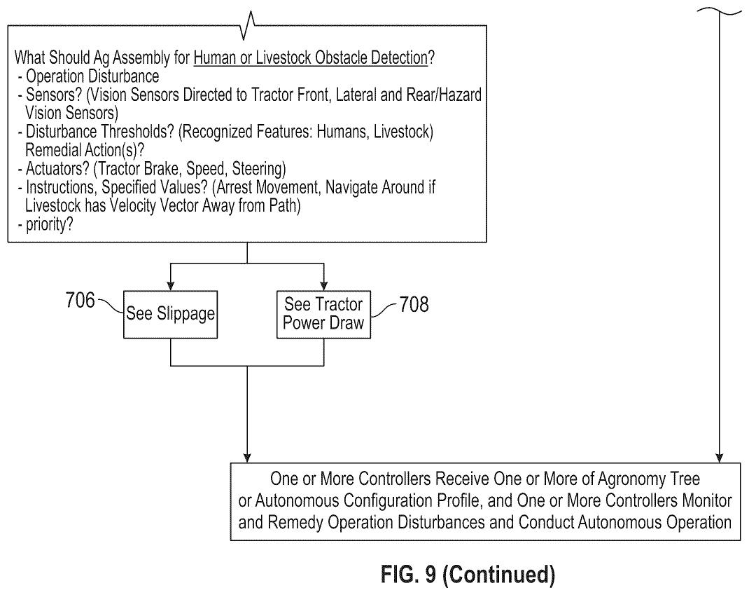

As discussed herein, the agronomy tree 700, branches 702, 704, operation disturbances and remedial actions associated with the branches 702, 704 or the like are determined and assembled by way of operator queries and set up of the autonomous driver system 600, HLC 430, autonomous vehicle controller 402 or the like. Examples of potential queries for an operator, for instance conducted at set up of the agricultural assembly for an autonomous operation, are provided in FIG. 9. In other examples, the agronomy tree 700, branches 702, 704 or the like are provided with agronomy trees, operation distubances and remedial actions or the like provided with characteristic bundles for the vehicle and implement included with the agricultural assembly. As discussed herein, the agronomy tree is in on example, assembled as a portion of a composite autonomous configuration profile generated as with the system shown in FIG. 8.

FIG. 8 is a schematic view of one example of a configurator 800 for generation of an autonomous configuration profile 820 for conduct of an agricultural operation by an agricultural assembly including an agricultural vehicle and an agricultural implement. The configurator 800 is included in one or more processors, for instance memories associated with the one or more processors. As described herein, the configurator 800 generates an agronomy tree as a component of the composite autonomous configuration profile 820.

The composite autonomous configuration profile 820 in an example is a collection of autonomous operation settings including, but not limited, operation type, tool height, gang height, gang angle, application rate, duty cycles, pressures, tool height, boom height, driving speed or the like selected from a catalog, online database, or developed through selections of sensors and actuators for an agricultural vehicle and agricultural implement selected as an agricultural assembly. The composite autonomous configuration profile 820 further includes the agronomy tree of operation disturbances and associated remedial actions, one example of an agronomy tree for an agricultural assembly including a tillage implement is shown in FIG. 7.

In one example, the composite autonomous configuration profile 820 bundled with the agronomy tree, along with a path plan are submitted to one or more autonomous controllers of the agricultural assembly. The controllers include, but are not limited to the HLC 430, autonomous driving controller 602, autonomous vehicle controller 402, autonomous implement controller 404 or the like (see FIGS. 4 and 6). The autonomous controllers, such as the autonomous driving controller 602, implement control of the implement and vehicle based on the autonomous configuration profile developed from the capabilities of one or more of a field, implement or vehicle. In one example, the autonomous controllers like the vehicle and implement controllers 402, 404 interact directly with the sensors, actuators or the like of the implement or vehicle. In another example, the autonomous controllers, such as the HLC 430, autonomous driving controller 602 or the like work through the vehicle and implement controllers 402, 404, and those controllers interpret instructions from one or more of the controllers 403, 602 and relay the interpreted instructions to the sensors, actuators or the like.

As shown in FIG. 8, the configurator 800 optionally begins with selection of a field or zone at 804. The selected field or zone includes associated characteristics, referred to as a field characteristic bundle, including one or more of a field map, boundaries, indexed obstacles (fences, water, ditches or the like), topography, headland profile, swath profile, planted crop (or lack thereof), husbandry specification (e.g., specified knife or disk depth, gang angle, agricultural product flow rate) or the like. In one example, the operator selects the field from a plurality of fields available, each field having a respective field characteristic bundle.

At 806 an agricultural implement is chosen from a database, catalog or virtual garage 808 of available implements (and optionally vehicles). For instance, the virtual garage 808 includes the implements available to an operator in their real world garage or on their farm. Each of the agricultural implements includes a respective implement characteristic bundle provided by the implement itself, an online database, database maintained by the operator or the like. The characteristic bundles for each of the implements includes characteristics associated with the implement. For instance, implement characteristics include, but are not limited to, weight, dimensions, hitch type, turning radius, number of row units, spacing of row units, implement tools, implement sensors provided with the implement and implement actuators provided with the implement. Examples of implement sensors and actuators are discussed herein including FIGS. 1-3.

At 810 an agricultural vehicle is chosen from a database, catalog or virtual garage 808 of available vehicles (and optionally implements). For instance, the virtual garage 808 includes the vehicles available to an operator in their real world garage or on their farm. Each of the agricultural vehicles includes a respective vehicle characteristic bundle provided by the vehicle itself, an online database, database maintained by the operator or the like. The characteristic bundles for each of the vehicles includes characteristics associated with the vehicle. For instance, vehicle characteristics include, but are not limited to, weight, dimensions, hitch type, engine and transmission characteristics, turning radius, motor or pump characteristics, ground engaging element spacing as well as vehicle sensors provided with the vehicle and vehicle actuators provided with the implement. Examples of vehicle sensors and actuators are discussed herein including FIGS. 1-3.

In another example, one or more of the implement or vehicle characteristic bundles includes agronomy tree branches populated with various operation disturbances that may arise with the implement or vehicle. In a tillage example, the operation disturbances for the tillage implement include fouling of tillage knives or disks, blocking of ground engaging elements (e.g., tires), incorrect surface finish, inaccurate implement depth or the like. With regard to the selected agricultural vehicle, the operation disturbances include, but are not limited to, slippage, tractor power draw, tire deflation or the like, The operation disturbance branches are further populated with one or more disturbance characteristics that are designated for monitoring with the implement, vehicle or both of implement and vehicle sensors and associated disturbance thresholds. In operation, monitoring of the disturbance characteristics with the implement or vehicle sensors (or both if available) is conducted and the observations are compared with disturbance thresholds of the branches including specified characteristic values, recognized features (e.g., tagged images or values) for AI modules or machine learning modules provided in some examples with the autonomous perception module 420 described herein. Satisfaction of the disturbance thresholds, including one or more of meeting or exceeding specified characteristics values or AI or machine learning identification of recognized features associated with the operation disturbance, as conducted by the recognition module 608 in FIG. 6 identifies the operation disturbance.

In other examples, the operation disturbance branches are populated with one or more remedial actions associated with the operation disturbances. Like the operation disturbances each of the vehicle or implement characteristic bundles optionally includes remedial actions associated with operation disturbances in the branches of the agronomy tree. The remedial actions include a collection of operations for conduct by the implement or vehicle to address (e.g., improve, mitigate or eliminate) the operation disturbance. In operation, the identification of the operation disturbance with the recognition module 608 of the interventional control module 606 (FIG. 6) initiates the selection of one or more remedial actions by the remedial action module 610 from the associated operation disturbance branch. The selected remedial actions are then implemented with the implementation module 612 with the implement (or vehicle) actuators, for instance provided with the implement characteristic bundle.

At 812, the configurator 800 builds out the autonomous agricultural operation and, where the characteristic bundles include agronomy tree information, branches or the likes, builds out the agronomy tree for use with the interventional control module 606 of the autonomous driving controller 602 (FIG. 6). In various examples, the building of the operation, agronomy tree or the like is conducted with a series of instructions, algorithm, macro or similar implemented by the processors associated with the architecture 400, a cloud based server or the like, represented by 814 in FIG. 8. The collection of characteristic bundles from the selected vehicle and implement of the agricultural assembly and the field provides a suite of capabilities across the vehicle and implement, and field characteristics to build the autonomous operation with the configurator 800. The built out autonomous operation is referred to herein as an initial version of a composite autonomous configuration profile. The configurator 800 builds out the autonomous operation based on those capabilities, with thresholds, prescribed actions, or the like associated with those capabilities. The building of the autonomous agricultural operation contrasts from using prebuilt autonomous operation templates associated with the existing vehicle, implement or the like (e.g., developed for the specified vehicle or implement) that are often developed for the base vehicle or implement and may not mesh well with varied model numbers, manufacturers, model years or the like.

In one example, at 812, the configurator 800 identifies an operation type (or types) based on the selected implement and implement characteristics in the associated characteristic bundle. The configurator 800 further designates sensors, actuators and tools from the characteristic bundles of the vehicle and implement, and sets thresholds (e.g., specified values including ranges of values) for conduct of the agricultural operation. The set thresholds including sensor thresholds for detection, actuator thresholds (e.g., thresholds, instructions or the like) for operation of actuators, and tool selections for conduct of the autonomous operation by the vehicle and implement.

The configurator 800, at 812, assembles the agronomy branches of operation disturbances, remedial actions and associated disturbance characteristic thresholds (e.g., specified values, including ranges of values; recognized features, such as tagged images or values) into an agronomy tree for use with the interventional control module 606 of the autonomous driving controller 602. Examples including slippage, tractor power draw, or the like are optionally provided with the vehicle characteristic bundle. Other examples, including tillage knife blockage, obstacle collision with a tillage disc, fouling of a row section of the tillage implement, incorrect surface finish, or the like are optionally provided with the implement characteristic bundle. The configurator 800 assembles these component branches into the agronomy tree and logs vehicle and implement sensors and actuators (included with the characteristic bundles) that are configured to respectively monitor for the operation disturbances and implement remedial actions to address the disturbances. The sensors and actuators may bridge across the vehicle and implement. For instance, an operation disturbance branch for a tillage implement row unit blockage is monitored with vehicle and implement sensors, such as torque sensors, load cells, video or camera sensors or the like. Similarly, vehicle and implement actuators address the disturbance in another example, such as by reversing of a tractor, lifting of the gang or row unit, change in gang angle or the like. The assembled agronomy tree is in one example generated separately or by itself without the autonomous configuration profile. In another example, the assembled agronomy tree is generated with the autonomous configuration profile, and is optionally bundled with the profile.

At 816 the configurator 800 includes queries for an operator. Queries include, but are not limited to, if/then statements; questions; opportunities for input; toggled selections, such as drop down menu selections; or the like. In one example, the queries includes questions related to conduct of the agricultural operation including, but not limited to, implement settings (including ranges) such as knife of disk depth, gang angle, gang height; agricultural product application flow rates, pressures, composition, concentration; vehicle speed, engine speed, end of row turn types, or the like. These answered queries are, in one example, generated based on the selected field, vehicle and implement. Answers to the queries refine the configuration profile from 812.

In another example, the queries permit the operator to edit and refine agronomy branches. For instance, the operator sets disturbance thresholds, instructions for remedial actions or the like. In other examples the operator specifies vehicle and implement sensors that monitor for operation disturbances, and similarly specifies vehicle and implement actuators for implementation of remedial actions. In still other examples, the operator queries permit the introduction (by the operator, from a catalog, online database or the like) of agronomy tree branches for operation disturbances with associated remedial actions. Example queries are shown in FIG. 9 (and referred to at 816 in FIG. 8) to set up operation disturbance branches of an agronomy tree for an agricultural assembly including a tractor and a tillage implement. Examples of queries for slippage, tractor power usage, incorrect surface finish, plugged or fouled baskets, plugged gang, and obstacle detection of humans are provided.

In one example, the operator answers queries to establish the operation disturbance (e.g., incorrect surface finish), and subsequently answers queries (questions, inputs or the like) for selection of available sensors of the vehicle or implement and setting of disturbance thresholds to permit identification of the operation disturbance, for instance with the recognition module 608 of the interventional control module 606. The operator specifies or selects remedial actions and selects actuators for conduct of the remedial actions along with instructions for operation of the actuators to accomplish the remedial actions.

At 820 the autonomous configuration profile is generated in a refined format after optional operator queries that refine the profile, generate or refine the agronomy tree or the like. The assembled agronomy tree is in one example generated separately or by itself without the autonomous configuration profile. In another example, the assembled agronomy tree is generated with the autonomous configuration profile, and is optionally bundled with the profile. At 822 the one or both of the autonomous configuration profile or the agronomy tree are collected and optionally bundled with a path plan for the autonomous operation. The path plan is optionally generated with the HLC 430, provided with an input field map, generated by the configurator 800 or guidance and navigation module 440. The path plan is bundled with the autonomous configuration profile and the agronomy tree and at 802 is submitted to the agricultural assembly 803 including, but not limited to, one or more of the HLC 430, autonomous vehicle controller 402, autonomous implement controller 404, autonomous driving controller 602 for conduct of the autonomous agricultural operation as well as identification and remediation of operation disturbances with the agronomy tree and the interventional control module 606 of the controller 602.

The agronomy tree described herein is optionally apportioned and submitted to associated controllers, such as the agricultural vehicle controller 402, the agricultural implement controller 404 and the HLC 430. For example, operation disturbance branches associated with the implement are directed to the implement controller 404, vehicle based disturbance branches are directed to the vehicle controller 402, and human, livestock or emergent disturbance branches are directed to the HLC 430. These controllers 402, 404, 430 then communicate with associated vehicle or implement sensors or actuators for monitoring of operation disturbances and conduct of remedial actions. In another example, the vehicle or implement controllers 402, 404, 430 cooperate with the other of the implement or vehicle controllers 404, 402, 430 (or sensors and actuators) to cooperatively make use of the associated sensors or actuators of the other implement or vehicle to address operation disturbances.

FIG. 9 is a block diagram example of an agronomy tree query array 900 for generating an agronomy tree having one or more or more operation disturbance branches. Optionally, the query array 900 is conducted and combined with operation disturbance branches provided from other sources including, but not limited to, one or more of the field, vehicle or implement characteristic bundles (see 804, 806, 810 in FIG. 8), an online database, USB drive provided with a vehicle or implement, cloud network or the like. In the example of vehicle or implement characteristic bundles, disturbance branches are optionally appended to the bundles by way of previous operator (farmer) input in prior seasons or operations, developer based updates or the like. In another example, the query array 900 provides a query for accessing operation disturbance branches from one or more of these sources.

As shown in FIG. 9, the agronomy tree query array 900 is optionally arranged in two portions, a vehicle query array 904 and an implement query array 906 with potential operation disturbances associated with the vehicle or implement provided within the respective array 904, 906. In other examples, the query array 900 is consolidated with vehicle and implement type disturbances provided together.

Each of the query arrays 904, 906 provide example queries for one or more potential operation disturbances. The example queries are, in on example, generated by the autonomous driving controller 602 based on the vehicle or implement selected as part of operation of the configurator 800. For instance, queries are provided based on disturbances that occur with the vehicle and implement.

Referring to the vehicle query array 904 as a first example, a plurality of queries are provided including those shown in FIG. 9. In one example, the queries begin with initial queries posed to the operator interacting with the agronomy tree query array. Example initial queries include “What should the agricultural assembly do for slippage?”, “What should the agricultural assembly do for Increased Tractor Power Usage?”, “What should the agricultural assembly do for Human or Livestock Detection?”. These initial queries, if selected by the operator, initiate supplemental queries including a series of queries for one or more of vehicle or implement sensor selection, “sensors?” for monitoring of the operation disturbance. Optionally, when “sensors” are selected, sensor options provided (e.g., in a dropdown menu or similar) are those sensors capable or recommended for monitoring of disturbance characteristics associated with the associated operation disturbance. In another example, the full collection of sensors for the vehicle and implement are available for selection, for instance to permit generation of individual sensor (and actuator) combinations based on operator experience or knowhow. The operator selects sensors from the options provided for the selected operation disturbance.

As further shown, the selected operation disturbance further includes the opportunity to specify disturbance thresholds for the selected sensors. The disturbance thresholds correspond to the capabilities of the selected sensors (e.g., capability to measure one or more disturbance characteristics). For instance, for a tachometer, thresholds are specified by the operator based on rotations per minute (rpm), including range of rpm, change in rpm or the like. For a pressure sensor, thresholds are specified based on pounds per square inch (psi), ranges of pressure, change in pressure or the like. For a video, camera or other vision sensor the disturbance threshold includes one or more recognized features, such as tags for recognized features, that cause an associated autonomous perception controller (see 420 in FIG. 4) to analyze the vision sensor captured image, video or the like for the feature. In the example of slippage, the recognized feature includes spinning ground engaging elements, sprayed soil, sprayed mud or the like. In another example, one or more of position, speed or the like is the disturbance characteristic measured with a GPS or RTK sensor, and the disturbance thresholds include a small change of position relative to engine or tire rotation, low speed relative to engine or tire rotation or the like.

The query array 904 provides remedial action options for the operation disturbance during its generation as an agronomy tree branch. As shown in FIG. 9 a remedial action query, “Remedial Action(s)?”, is provided and the operator has an opportunity to designate one or more remedial actions for conduct with the agricultural assembly actuators (e.g., one or more of vehicle or implement actuators). In a similar manner to specification of sensors, the operator is provided the opportunity to specify one or more vehicle or implement actuators for conduct of the remedial action. The actuators include one or more of the full set of actuators for the vehicle and implement, a suggested set of actuators capable of remedying the operation disturbance or the like.

Additional queries are provided that permit the selection (e.g., from a dropdown menu, input or the like) of instructions for operation of the actuators, specified values for actuation, order of actuation for the various actuators or the like. In some examples, the instructions include the input or opportunity to input instructions to continue monitoring of the operation disturbance during conduct of remedial actions, for instance to arrest the remedial action if the operation disturbance is addressed (e.g., decreased, mitigated or eliminated). In the context of the slippage example in FIG. 9, the selected actuators include one or more gang angle actuators, a height actuator for a back gang, and an implement height actuator. As shown in FIG. 7, at 716 these actuators include instructions for their operation, priority of operation, and continued monitoring of a disturbance characteristic during their implementation.

Another example of queries is provided with the implement query array 906. In this example, the queries begin with initial queries posed to the operator interacting with the agronomy tree query array 900. Example initial queries include “What should the agricultural assembly do for incorrect soil surface finish?” or “What should the agricultural assembly do for plugged basket?”. These initial example queries, if selected by the operator, initiate supplemental queries including a series of queries for one or more of vehicle or implement sensor selection, “sensors?” for monitoring of the operation disturbance. Optionally, when “sensors” are selected, sensor options provided (e.g., in a dropdown menu or similar) are those sensors capable or recommended for monitoring of disturbance characteristics associated with the associated operation disturbance. In another example, the full collection of sensors for the vehicle and implement are available for selection. In a similar manner to the vehicle query array 904, the operator selects sensors from the options provided for the selected operation disturbance.

As further shown, the selected operation disturbance further includes the opportunity to specify disturbance thresholds for the selected sensors. For instance, for a load cell or pressure sensor provided with a hydraulic cylinder, thresholds are specified by the operator based on force (Newtons, pounds force or the like) or pressure (psi, kpa or the like). For a video, camera or other vision sensor the disturbance threshold includes one or more recognized features, such as tags for recognized features, that cause an associated autonomous perception controller (see 420 in FIG. 4) to analyze the vision sensor captured image, video or the like for the feature. In the example of incorrect soil surface finish, the recognized feature includes soil agglomeration, clod profile or size or similar.

The query array 906 provides remedial action options for the operation disturbance during its generation as an agronomy tree branch. As shown in FIG. 9 for the implement query array 906 a remedial action query, “Remedial Action(s)?”, is provided and the operator has an opportunity to designate one or more remedial actions for conduct with the agricultural assembly actuators (e.g., one or more of vehicle or implement actuators). In a similar manner to specification of sensors, the operator is provided the opportunity to specify one or more vehicle or implement actuators for conduct of the remedial action(s). The actuators include one or more of the full set of actuators for the vehicle and implement, a suggested set of vehicle and actuators capable of remedying the operation disturbance or the like.

Additional queries are provided that permit the selection (e.g., from a dropdown menu, input or the like) of instructions for operation of the actuators, specified values for actuation, order of actuation for the various actuators or the like. In some examples, the instructions include the input or opportunity to input instructions to continue monitoring of the operation disturbance during conduct of remedial actions, for instance to arrest the remedial action if the operation disturbance is addressed (e.g., decreased, mitigated or eliminated). In the context of the soil surface finish example in FIG. 9, the selected actuators include one or more disk elevation actuators (or depth), gang angle actuators, gang height actuators or the like. The operator then selects one or more instructions, such as specified values or the like for actuators. In one example, gang angle is initially adjusted three degrees closer to the direction of travel, disk elevation of a subset of disks (e.g., every other disk) is then raised two inches, and gang height is then raised one inch. Optionally, conduct of these various remedial actions is done in parallel, in series or the like according to the specifications of the operator (farmer). In another example, continued monitoring of the disturbance is specified while conducting remedial actions, and upon addressing the disturbance remedial actions are arrested (including abbreviation, stopping or gradually decreasing conduct of the action).

Upon completion of the operation disturbance branch, the branch is provided as a component of the agronomy tree. For instance, the example branches 706, 708 from FIG. 7 are provided as the agronomy tree to the autonomous driving controller 602 (FIG. 6) for use with the interventional control module 606 to identify operation disturbances and implement remedial actions for the identified disturbances. Optionally, the agronomy tree is apportioned and provided as components, with operation disturbance branches related to vehicle disturbances provided to the autonomous vehicle controller 402 (FIG. 4), implement related disturbance branches provided to the autonomous implement controller 404, and one or more of safety (human, livestock) disturbance branches, path planning disturbance branches or the like provided to the HLC 430.

### Various Notes and Aspects

Aspect 1 can include subject matter such as an autonomous driver system for an agricultural vehicle assembly, the autonomous driver system includes: a sensor interface configured for coupling with one or more of vehicle sensors of an agricultural vehicle or implement sensors of an agricultural implement; a function interface configured for coupling with one or more of vehicle actuators of the agricultural vehicle or implement actuators of the agricultural implement; and one or more hardware processors for an autonomous driving controller in communication with the sensor and function interfaces, and at least one memory storing instructions that, when executed by the one or more hardware processors, causes the one or more hardware processors to: autonomously implement a planned agricultural operation with the agricultural vehicle and the agricultural implement; and identify and remedy one or more operation disturbances outside of the planned agricultural operation, wherein identifying and remedying includes: identifying the one or more operation disturbances outside of the planned agricultural operation with one or more of the vehicle sensors or the implement sensors; selecting one or more remedial actions for the one or more operation disturbances; and implementing the selected one or more remedial actions with one or more of the vehicle actuators or the implement actuators.

Aspect 2 can include, or can optionally be combined with the subject matter of Aspect 1, to optionally include wherein identifying the one or more operation disturbances includes comparing measurements of one or more of the vehicle sensors or the implement sensors with an agronomy tree.

Aspect 3 can include, or can optionally be combined with the subject matter of one or any combination of Aspects 1 or 2 to optionally include wherein selecting the one or more remedial actions including selecting the one or more remedial actions from the agronomy tree.

Aspect 4 can include, or can optionally be combined with the subject matter of one or any combination of Aspects 1-3 to optionally include wherein the agronomy tree includes a plurality of operation disturbance and remedy branches, and each operation disturbance and remedy branch includes at least: a disturbance designation for each operation disturbance of the one or more operation disturbances and disturbance characteristics associated with the disturbance designation, wherein one or more of the vehicle sensors or the implement sensors are configured to sense characteristics corresponding to the disturbance characteristics; and a remedy designation for each remedial action of the one or more remedial actions and actuator instructions associated with the remedy designation, wherein one or more of the vehicle actuators or the implement actuators are configured to implement the actuator instructions.

Aspect 5 can include, or can optionally be combined with the subject matter of one or any combination of Aspects 1-4 to optionally include wherein implementing the selected one or more remedial actions includes prioritizing implementing of the selected one or more remedial actions to override the autonomous implementing of the planned agricultural operation.

Aspect 6 can include, or can optionally be combined with the subject matter of Aspects 1-5 to optionally include wherein implementing the selected one or more remedial actions includes re-initiating the planned agricultural operation after implementing the selected one or more remedial actions.

Aspect 7 can include, or can optionally be combined with the subject matter of Aspects 1-6 to optionally include an autonomous perception module in communication with the sensor interface.

Aspect 8 can include, or can optionally be combined with the subject matter of Aspects 1-7 to optionally include wherein the autonomous perception module includes one or more hardware processors having a machine learning application or artificial intelligence application for identifying operation disturbances with observations of one or more of the vehicle sensors or the implement sensors.

Aspect 9 can include, or can optionally be combined with the subject matter of Aspects 1-8 to optionally include wherein identifying the one or more operation disturbances includes identifying operation disturbances with the machine learning application or artificial intelligence application.

Aspect 10 can include, or can optionally be combined with the subject matter of Aspects 1-9 to optionally include wherein the one or more operation disturbances include an implement blockage, implement fouling, forthcoming obstacle, engaged obstacle, fouled spray nozzle, tire deflation, tire slippage, or vehicle power draw.

Aspect 11 can include, or can optionally be combined with the subject matter of Aspects 1-10 to optionally include wherein the one or more vehicle sensors include one or more of visual, video, laser, radar, LiDAR, ultrasound, torque, speed, acceleration, tachometer, dynamometer, position, load cell, radio-frequency identification (RFID), short range radio frequency, infrared, temperature, encoder, GPS or real-time kinematic (RTK) sensors.

Aspect 12 can include, or can optionally be combined with the subject matter of Aspects 1-11 to optionally include wherein the one or more implement sensors include one or more of visual, video, laser, radar, LiDAR, ultrasound, pressure, flow meter, load cell, radio-frequency identification (RFID), short range radio frequency, infrared, temperature, encoder, moisture, hyperspectral, yield monitor, GPS, real-time kinematic (RTK) or position sensors.

Aspect 13 can include, or can optionally be combined with the subject matter of Aspects 1-12 to optionally include wherein the one or more vehicle actuators include one or more of throttle, brake, transmission, steering, hydraulic pressure, hydraulic flow rate, hydraulic valve, hydraulic cylinder, control valve, centrifugal clutch, variable speed pulley actuators.

Aspect 14 can include, or can optionally be combined with the subject matter of Aspects 1-13 to optionally include wherein the one or more implement actuators include one or more of gang angle, gang height, implement height, disk depth, knife depth, hydraulic pressure, hydraulic flow rate, hydraulic valve, hydraulic cylinder, agricultural product pump, control valve, modulating nozzle, row section, pneumatic actuators, centrifugal clutch, variable speed pulley actuators.

Aspect 15 can include, or can optionally be combined with the subject matter of Aspects 1-14 to optionally include wherein the agricultural implement includes a tillage implement.

Aspect 16 can include, or can optionally be combined with the subject matter of Aspects 1-15 to optionally include the tillage implement.

Aspect 17 can include, or can optionally be combined with the subject matter of Aspects 1-16 to optionally include the agricultural vehicle.

Aspect 18 can include, or can optionally be combined with the subject matter of Aspects 1-17 to optionally include wherein the one or more hardware processors include one or more of the sensor interface or the function interface.

Aspect 19 can include, or can optionally be combined with the subject matter of Aspects 1-18 to optionally include a method for generating an agronomy tree of an autonomous driver system, the method comprising: generating an operation disturbance branch for an operation disturbance, generating includes: collecting one or more disturbance characteristics; and associating one or more disturbance thresholds with the one or more collected disturbance characteristics; associating one or more remedial actions with the operation disturbance branch, the one or more remedial actions each include: instructions for autonomous conduct of a remedial action of the one or more remedial actions with an agricultural vehicle or an agricultural implement; and wherein sensing disturbance characteristics satisfying the disturbance thresholds are indicative of the operation disturbance, and implementing of the associated one or more remedial actions is configured to address the operation disturbance.

Aspect 20 can include, or can optionally be combined with the subject matter of Aspects 1-19 to optionally include wherein generating the operation disturbance branch and associating one or more remedial actions with the operation disturbance branch are repeated for a plurality of different operation disturbances.

Aspect 21 can include, or can optionally be combined with the subject matter of Aspects 1-20 to optionally include wherein generating the operation disturbance branch and associating one or more remedial actions with the operation disturbance branch include operator queries for one or more of the disturbance characteristics, the disturbance thresholds or the remedial actions.

Aspect 22 can include, or can optionally be combined with the subject matter of Aspects 1-21 to optionally include wherein generating the operation disturbance branch and associating one or more remedial actions with the operation disturbance branch include receiving one or more of an agricultural vehicle characteristic bundle or agricultural implement characteristic bundle having one or more of the disturbance characteristics, the disturbance thresholds or the remedial actions for the operation disturbance.

Aspect 23 can include, or can optionally be combined with the subject matter of Aspects 1-22 to optionally include wherein generating the operation disturbance branch and associating one or more remedial actions with the operation disturbance branch include receiving one or more of the disturbance characteristics, the disturbance thresholds or the remedial actions for the operation disturbance from an operation disturbance and remedy log.

Aspect 24 can include, or can optionally be combined with the subject matter of Aspects 1-23 to optionally include wherein the one or more disturbance thresholds includes one or more of: specified characteristic values for the one or more collected disturbance characteristics; and recognized features for use with AI or machine learning modules.

Aspect 25 can include, or can optionally be combined with the subject matter of Aspects 1-24 to optionally include sensing disturbance characteristics according to the collected one or more disturbance characteristics; identifying the operation disturbance according to satisfaction of the one or more disturbance thresholds; and autonomously implementing the associated one or more remedial actions to address the operation disturbance according to identification of the operation disturbance.

Aspect 26 can include, or can optionally be combined with the subject matter of Aspects 1-25 to optionally include wherein autonomously implementing the associated one or more remedial actions includes operating one or more vehicle actuators of an agricultural vehicle or implement actuators of an agricultural implement.

Aspect 27 can include, or can optionally be combined with the subject matter of Aspects 1-26 to optionally include wherein the one or more disturbance thresholds includes one or more recognized features for use with one or more of an AI module or machine learning module, and identifying the operation disturbance according to satisfaction of the one or more disturbance thresholds includes analyzing sensed disturbance characteristics with one or more of the AI module or the machine learning module.

Aspect 28 can include, or can optionally be combined with the subject matter of Aspects 1-27 to optionally include wherein autonomously implementing the associated one or more remedial actions includes interrupting an autonomous agricultural operation, implementing the one or more remedial actions, and re-initiating the autonomous agricultural operation.

Aspect 29 can include, or can optionally be combined with the subject matter of Aspects 1-28 to optionally include wherein autonomously implementing the associated one or more remedial actions includes implementing the one or more remedial actions while conducting an autonomous agricultural operation.

Aspect 30 can include, or can optionally be combined with the subject matter of Aspects 1-29 to optionally include wherein associating the one or more remedial actions with the operation disturbance branch includes associating a plurality of remedial actions with the operation disturbance branch, each of the remedial actions of the plurality of remedial actions having a priority for implementation relative to other remedial actions of the plurality of remedial actions.

Aspect 31 can include, or can optionally be combined with the subject matter of Aspects 1-30 to optionally include wherein generating includes selecting one or more of vehicle or implement sensors configured for collection of the one or more disturbance characteristics; and associating the one or more remedial actions with the operation disturbance branch includes selecting one or more vehicle actuators configured for conducting the one or more remedial actions.

Each of these non-limiting aspects can stand on its own or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method aspects or examples described herein can be machine or computer-implemented at least in part. Some aspects or examples can include a computer-readable medium or machine-readable medium encoded with instructions operable to configure an electronic device to perform methods as described in the above aspects or examples. An implementation of such methods can include code, such as microcode, assembly language code, a higher-level language code, or the like. Such code can include computer readable instructions for performing various methods. The code may form portions of computer program products. Further, in an aspect or example, the code can be tangibly stored on one or more volatile, non-transitory, or non-volatile tangible computer-readable media, such as during execution or at other times. Aspects or examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An autonomous driver system for an agricultural vehicle assembly, the autonomous driver system includes:
a sensor interface configured for coupling with one or more of vehicle sensors of an agricultural vehicle or implement sensors of an agricultural implement;
a function interface configured for coupling with one or more of vehicle actuators of the agricultural vehicle or implement actuators of the agricultural implement; and
one or more hardware processors for an autonomous driving controller in communication with the sensor and function interfaces, and at least one memory storing instructions that, when executed by the one or more hardware processors, causes the one or more hardware processors to:
autonomously implement a planned agricultural operation with the agricultural vehicle and the agricultural implement; and
identify and remedy one or more operation disturbances outside of the planned agricultural operation, wherein identifying and remedying includes:
identifying the one or more operation disturbances outside of the planned agricultural operation with one or more of the vehicle sensors or the implement sensors;
selecting one or more remedial actions for the one or more operation disturbances; and
implementing the selected one or more remedial actions with one or more of the vehicle actuators or the implement actuators.

2. The autonomous driver system of claim 1, wherein identifying the one or more operation disturbances includes comparing measurements of one or more of the vehicle sensors or the implement sensors with an agronomy tree.

3. The autonomous driver system of claim 2, wherein selecting the one or more remedial actions including selecting the one or more remedial actions from the agronomy tree.

4. The autonomous driver system of claim 3, wherein the agronomy tree includes a plurality of operation disturbance and remedy branches, and each operation disturbance and remedy branch includes at least:
a disturbance designation for each operation disturbance of the one or more operation disturbances and disturbance characteristics associated with the disturbance designation, wherein one or more of the vehicle sensors or the implement sensors are configured to sense characteristics corresponding to the disturbance characteristics; and
a remedy designation for each remedial action of the one or more remedial actions and actuator instructions associated with the remedy designation, wherein one or more of the vehicle actuators or the implement actuators are configured to implement the actuator instructions.

5. The autonomous driver system of claim 1, wherein implementing the selected one or more remedial actions includes prioritizing implementing of the selected one or more remedial actions to override the autonomous implementing of the planned agricultural operation.

6. The autonomous driver system of claim 5, wherein implementing the selected one or more remedial actions includes re-initiating the planned agricultural operation after implementing the selected one or more remedial actions.

7. The autonomous driver system of claim 1 comprising an autonomous perception module in communication with the sensor interface.

8. The autonomous driver system of claim 7, wherein the autonomous perception module includes one or more hardware processors having a machine learning application or artificial intelligence application for identifying operation disturbances with observations of one or more of the vehicle sensors or the implement sensors.

9. The autonomous driver system of claim 8, wherein identifying the one or more operation disturbances includes identifying operation disturbances with the machine learning application or artificial intelligence application.

10. The autonomous driver system of claim 1, wherein the one or more operation disturbances include an implement blockage, implement fouling, forthcoming obstacle, engaged obstacle, fouled spray nozzle, tire deflation, tire slippage, or vehicle power draw.

11. The autonomous driver system of claim 1, wherein the one or more vehicle sensors include one or more of visual, video, laser, radar, LiDAR, ultrasound, torque, speed, acceleration, tachometer, dynamometer, position, load cell, radio-frequency identification (RFID), short range radio frequency, infrared, temperature, encoder, GPS or real-time kinematic (RTK) sensors.

12. The autonomous driver system of claim 1, wherein the one or more implement sensors include one or more of visual, video, laser, radar, LiDAR, ultrasound, pressure, flow meter, load cell, radio-frequency identification (RFID), short range radio frequency, infrared, temperature, encoder, moisture, hyperspectral, yield monitor, GPS, real-time kinematic (RTK) or position sensors.

13. The autonomous driver system of claim 1, wherein the one or more vehicle actuators include one or more of throttle, brake, transmission, steering, hydraulic pressure, hydraulic flow rate, hydraulic valve, hydraulic cylinder, control valve, centrifugal clutch, variable speed pulley actuators.

14. The autonomous driver system of claim 1, wherein the one or more implement actuators include one or more of gang angle, gang height, implement height, disk depth, knife depth, hydraulic pressure, hydraulic flow rate, hydraulic valve, hydraulic cylinder, agricultural product pump, control valve, modulating nozzle, row section, pneumatic actuators, centrifugal clutch, variable speed pulley actuators.

15. The autonomous driver system of claim 1, wherein the agricultural implement includes a tillage implement.

16. The autonomous driver system of claim 15 comprising the tillage implement.

17. The autonomous driver system of claim 1 comprising the agricultural vehicle.

18. The autonomous driver system of claim 1, wherein the one or more hardware processors include one or more of the sensor interface or the function interface.

19. A method for generating an agronomy tree of an autonomous driver system, the method comprising:
generating an operation disturbance branch for an operation disturbance, generating includes:
collecting one or more disturbance characteristics; and
associating one or more disturbance thresholds with the one or more collected disturbance characteristics;
associating one or more remedial actions with the operation disturbance branch, the one or more remedial actions each include:
instructions for autonomous conduct of a remedial action of the one or more remedial actions with an agricultural vehicle or an agricultural implement; and
wherein sensing disturbance characteristics satisfying the disturbance thresholds are indicative of the operation disturbance, and implementing of the associated one or more remedial actions is configured to address the operation disturbance.

20. The method of claim 19, wherein generating the operation disturbance branch and associating one or more remedial actions with the operation disturbance branch are repeated for a plurality of different operation disturbances.

21. The method of claim 19, wherein generating the operation disturbance branch and associating one or more remedial actions with the operation disturbance branch include operator queries for one or more of the disturbance characteristics, the disturbance thresholds or the remedial actions.

22. The method of claim 19, wherein generating the operation disturbance branch and associating one or more remedial actions with the operation disturbance branch include receiving one or more of an agricultural vehicle characteristic bundle or agricultural implement characteristic bundle having one or more of the disturbance characteristics, the disturbance thresholds or the remedial actions for the operation disturbance.

23. The method of claim 19, wherein generating the operation disturbance branch and associating one or more remedial actions with the operation disturbance branch include receiving one or more of the disturbance characteristics, the disturbance thresholds or the remedial actions for the operation disturbance from an operation disturbance and remedy log.

24. The method of claim 19, wherein the one or more disturbance thresholds includes one or more of:
specified characteristic values for the one or more collected disturbance characteristics; and
recognized features for use with AI or machine learning modules.

25. The method of claim 19 comprising:
sensing disturbance characteristics according to the collected one or more disturbance characteristics;
identifying the operation disturbance according to satisfaction of the one or more disturbance thresholds; and
autonomously implementing the associated one or more remedial actions to address the operation disturbance according to identification of the operation disturbance.

26. The method of claim 25, wherein autonomously implementing the associated one or more remedial actions includes operating one or more vehicle actuators of an agricultural vehicle or implement actuators of an agricultural implement.

27. The method of claim 25, wherein the one or more disturbance thresholds includes one or more recognized features for use with one or more of an AI module or machine learning module, and identifying the operation disturbance according to satisfaction of the one or more disturbance thresholds includes analyzing sensed disturbance characteristics with one or more of the AI module or the machine learning module.

28. The method of claim 25, wherein autonomously implementing the associated one or more remedial actions includes interrupting an autonomous agricultural operation, implementing the one or more remedial actions, and re-initiating the autonomous agricultural operation.

29. The method of claim 25, wherein autonomously implementing the associated one or more remedial actions includes implementing the one or more remedial actions while conducting an autonomous agricultural operation.

30. The method of claim 19, wherein associating the one or more remedial actions with the operation disturbance branch includes associating a plurality of remedial actions with the operation disturbance branch, each of the remedial actions of the plurality of remedial actions having a priority for implementation relative to other remedial actions of the plurality of remedial actions.

31. The method of claim 19, wherein generating includes selecting one or more of vehicle or implement sensors configured for collection of the one or more disturbance characteristics; and associating the one or more remedial actions with the operation disturbance branch includes selecting one or more vehicle actuators configured for conducting the one or more remedial actions.
